(19) United States
(12) Patent Application Publication
(10) Pub. No.: US 2002/0091557 A1
(43) Pub. Date: Jul. 11, 2002

(54) Method for facilitating transactions of life sciences opportunities

(76) Inventor: Srinivas Akkaraju, San Mateo, CA (US)

Correspondence Address: Pennie & Edmonds, LLP, 3300 Hillview Avenue, Palo Alto, CA, 94304, US

(21) Appl. No.: 09/756,984

(22) Filed: Jan. 8, 2001

(51) Int. Cl. G06F 17/60; H04L 9/00

(52) U.S. Cl. 705/7; 705/80; 705/37; 705/1

(57) ABSTRACT

Answers to predetermined life sciences opportunity questions are firstly received from a first party, preferably a seller of a life sciences opportunity. Responses to the predetermined life sciences opportunity questions are then acquired from a second party, preferably a buyer of a life sciences opportunity. A first sum is subsequently calculated of all of the responses that match the answers for each of said predetermined life sciences opportunity questions, and from the answers and the responses, a second sum is computed of all of the questions that both the first party and the second party deem to be applicable to the transaction, for each of said predetermined life sciences opportunity questions. The first sum and the second sum are finally displayed to the second party, such that the second party can assess the life sciences opportunity.

The present invention relates generally to locating life sciences opportunities that reflect a searcher's requirements, and more particularly to a method for locating and assessing life sciences opportunities via an electronic network.

### BACKGROUND OF THE INVENTION

With growing competition in the life sciences industry, biotechnology and pharmaceutical companies are under increasing pressure to develop more and better life sciences products. To meet these demands, biotechnology and pharmaceutical companies must often rely on each other to find new life sciences products which they then develop through joint ventures or licensing. This reliance has led to increasing partnering activity between and among life sciences companies and an increased need to seek out new life sciences opportunities.

Illustratively, a large pharmaceutical company interested in producing a cancer drug will often seek out smaller companies that have already done the initial research and are ready to conduct clinical trials. By taking advantage of work done by the smaller company, the larger company can significantly reduce the time required to bring a cancer drug to market. Similarly, small pharmaceutical companies often do not have the resources required to bring a drug to market. Thus, a small company that has done the initial research and is ready to conduct clinical trials must partner with a large pharmaceutical company and share in the costs of conducting such trials. Alternatively, the smaller company will license the drug to a large pharmaceutical company and let it bring the drug to market. Thus, pharmaceutical and biotechnology companies are always in search of new life sciences opportunities that might be useful in their product development or partnering with a life sciences company that is seeking a new life sciences opportunity.

Additionally, large life sciences companies are often inundated with opportunities from companies interested in selling or licensing life sciences products. Often these selling companies present information in a manner that does not permit quick and easy comparison among the available opportunities. Thus, the company must spend considerable time and resources reviewing and analyzing the voluminous information provided by the selling companies to determine which opportunities require further investigation.

Moreover, current procedures for locating and assessing life sciences products are cumbersome, time-consuming, and often lead to an unsuccessful outcome. In order to assess the value of a life sciences product, companies must read and analyze large volumes of data generated during the development phase of the life sciences product and conduct in-person meetings with the selling companies. Often, after spending considerable time and effort reviewing the data and conducting such meetings, the searching company concludes that the opportunity does not meet its needs, thereby amounting to a waste of valuable resources.

Existing electronic systems, such as WWW.PHARMA-TRANSFER.COM, provide an electronic database of available life sciences opportunities. However, these systems do not organize the data in a standardized format or consider the buyer's needs when searching for opportunities for the buyer. Other electronic systems, such as WWW.PHARMALICENSING.COM, contain vast amounts of information in large databases that are difficult to navigate. Additionally, the information provided by these electronic systems is not reviewed for scientific merit. Thus, a buyer must conduct further investigation to determine whether the information provided by the seller is accurate and not just marketing puffery.

For the foregoing reasons, there is a need in the art for an electronic system that locates life sciences opportunities based on the buyer's requirements, an electronic system where the information provided by the seller has been reviewed for scientific merit, and an electronic system that presents information in a standardized format, facilitating a quick comparison of available life sciences opportunities.

### SUMMARY OF THE INVENTION

The invention provides for a system and method for locating and assessing life sciences opportunities that satisfy a searcher's requirements. In the preferred embodiment, Answers to predetermined life sciences opportunity questions are firstly received from a first party, preferably a seller of a life sciences opportunity. Responses to the predetermined life sciences opportunity questions are then acquired from a second party, preferably a buyer of a life sciences opportunity. A first sum is subsequently calculated of all of the responses that match the answers for each of said predetermined life sciences opportunity questions, and from the answers and the responses, a second sum is computed of all of the questions that both the first party and the second party deem to be applicable to the transaction, for each of said predetermined life sciences opportunity questions. The first sum and the second sum are finally displayed to the second party, such that the second party can assess the life sciences opportunity.

In the preferred embodiment, the sums are displayed as a ratio, with the numerator containing the first sum and the denominator containing the second sum. This ratio facilitates a quick assessment of how a life sciences product matches the transnational requirements of the second party.

### BRIEF DESCRIPTION OF THE DRAWINGS

Additional objects and features of the invention will be more readily apparent from the following detailed description and appended claims when taken in conjunction with the drawings, in which:

FIG. 1 illustrates a system for locating and assessing life sciences opportunities in accordance with an embodiment of the invention;

FIG. 2 illustrates an opportunity data structure in accordance with an embodiment of the invention;

FIG. 3 illustrates a graphical user interface (GUI) of an exemplary relevance ratio question set for an opportunity type in accordance with an embodiment of the invention;

FIG. 4 illustrates an opportunity type data structure in accordance with an embodiment of the invention;

FIG. 5 illustrates a data structure for storing buyer information in accordance with an embodiment of the invention;

FIG. 6 illustrates a data structure for storing a buyer's preferences in accordance with an embodiment of the invention;

FIG. 7 illustrates a GUI used for performing various tasks in accordance with an embodiment of the invention;

FIG. 8 illustrates a GUI used for posting opportunities in accordance with an embodiment of the invention;

FIG. 9 illustrates a GUI showing a drop down menu on a page used for posting opportunities in accordance with an embodiment of the invention;

FIG. 10 illustrates a GUI for uploading information packets for an opportunity in accordance with an embodiment of the invention;

FIGS. 11A and 11B illustrate the processing steps performed when posting an opportunity in accordance with an embodiment of the invention;

FIG. 12 illustrates a GUI containing a company's opportunities in accordance with an embodiment of the invention;

FIG. 13 illustrates a GUI for entering a buyer's search criteria in accordance with an embodiment of the invention;

FIGS. 14A and 14B illustrate the processing steps performed when searching for opportunities in accordance with an embodiment of the invention;

FIG. 15 illustrates the processing steps performed when searching for opportunities in accordance with an embodiment of the invention;

FIG. 16 illustrates the processing steps performed when generating a result in accordance with an embodiment of the invention;

FIG. 17 illustrates a result GUI in accordance with an embodiment of the invention;

FIG. 18 illustrates a GUI containing detailed description of an opportunity matching the buyer's search criteria in accordance with an embodiment of the invention;

FIG. 19 illustrates a GUI containing the buyer's responses, the seller's responses and the company's responses to the Relevance Ratio question set in accordance with an embodiment of the invention;

FIG. 20 illustrates a GUI used to edit a buyer's priorities in accordance with an embodiment of the invention;

FIG. 21 illustrates a personal profile GUI in accordance with an embodiment of the invention;

FIGS. 22A and 22B illustrate the processing steps performed when editing a buyer's priorities in accordance with an embodiment of the invention;

FIG. 23 illustrates a GUI containing the buyer's opportunity filters for each opportunity type in accordance with an embodiment of the invention;

FIG. 24 illustrates a GUI for entering a buyer's search criteria for creating an opportunity filter in accordance with an embodiment of the invention; and

FIGS. 25A and 25B illustrate the processing steps performed when creating an opportunity filter in accordance with an embodiment of the invention.

Like reference numerals refer to corresponding parts throughout the several views of the drawings.

### DESCRIPTION OF THE PREFERRED EMBODIMENTS

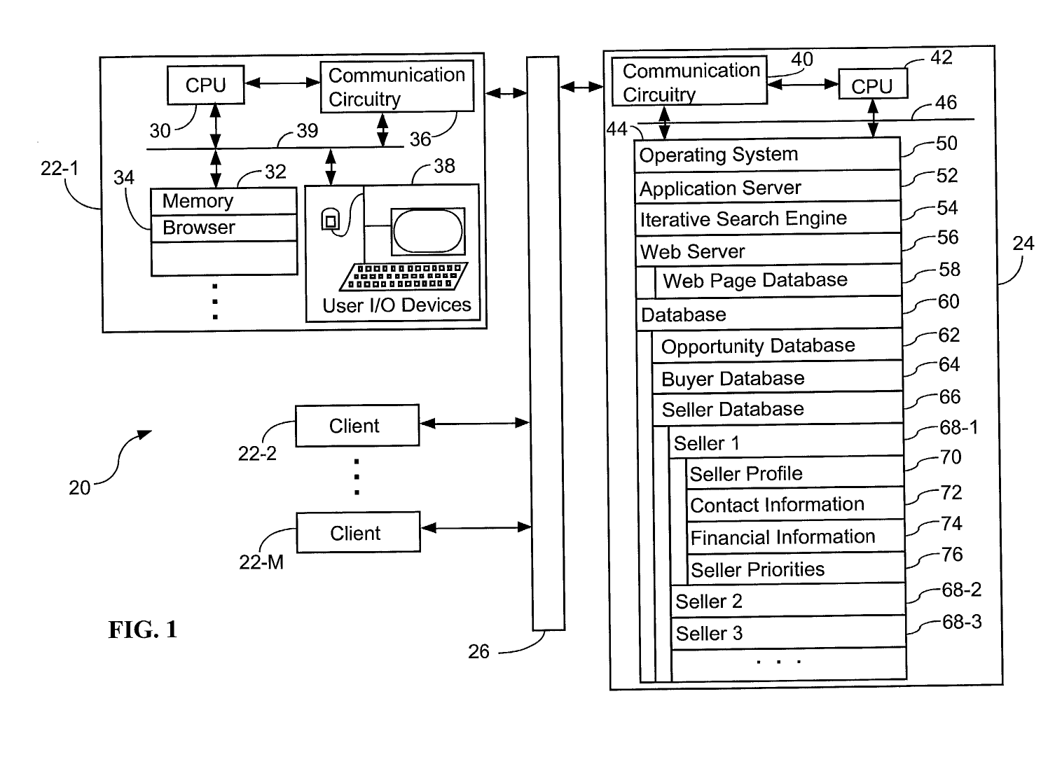

FIG. 1 illustrates a system for locating and assessing life sciences opportunities in accordance with an embodiment of the invention. Although the preferred embodiment is described in the context of a buyer and a seller, those skilled in the art will appreciate that the invention can be practiced by any two parties where a party is a buyer, a seller or both a buyer and a seller. In the following description, the first party is a buyer and the second party is a seller.

System 20 facilitates the exchange of information about life sciences opportunities between a first party and a second party. A life sciences opportunity is any technology, therapeutic, medical device, diagnostic, know-how in the life sciences industry, or the like. Life Sciences opportunities generally include those opportunities within Standard Industrial Code (SIC) industry group 283 or those opportunities within North American Industry Classification System (NAICS) industry group 3254. A buyer is an entity such as an individual, a business, or an institution that is interested in purchasing a life sciences opportunity, obtaining a license for a life sciences opportunity, partnering with a company that is selling a life sciences opportunity, or the like. A seller is an entity, such as an individual, a business or an institution, that is interested in licensing its life sciences opportunity, selling its life sciences opportunity, partnering with a life sciences company, or the like.

System 20 includes a plurality of clients 22 and at least one server 24. Clients 22 and server 24 are connected by a network 26. Network 26 is a local area network (LAN), wide area network (WAN), metropolitan area network (MAN), an intranet, or preferably the Internet. In one embodiment, system 20 is a standalone system on which a buyer can search for an opportunity or a seller can post an opportunity.

Client 22 is any computing device that includes a Central Processing Unit (CPU) 30; a memory (primary and/or secondary) 32; communication circuitry 36; a user input/output device 38; and a bus 39 that interconnects these components. The communication circuitry 36 is used for transmitting and receiving data between client 22 and network 26. Memory 32 typically stores computer programs, including network access software, such as a browser 34 which is used to view web pages on a display of the input/output device 38. A user using a client 22 is a buyer, a seller, or both a buyer and a seller.

Server 24 includes standard server components, including: communication circuitry 40; a CPU 42; a memory (primary and/or secondary) 44; and, a bus 46 that interconnects these components. The communication circuitry 40 is used for transmitting and receiving data between server 24 and network 26. Memory 44 stores a set of computer programs and files used to implement the processing associated with the invention. In particular, memory 44 includes an Operating System 50, an Application Server 52, an Iterative Search Engine 54, a Web Server 56, and a Database 60. In the preferred embodiment, Database 60 is stored on another server 24.

Operating System 50 stores instructions for communicating, accessing, storing, and searching data. Operating System 50 can be any operating system, including SOLARIS®, WINDOWS NT®, LINUX®, or MACOS®. Application Server 52 contains instructions for communicating data between Web server 56 and Database 60 and for processing data sent to or received from Web server 56. Iterative Search Engine 54 includes instructions for searching Database 60 for opportunities that match a buyer's search criteria. Web server 56 is used to communicate with browser 34 via network 26 and to provide web page content to browser 34. Web server 56 contains web page database 58, and is used to transmit and receive information to and from clients 22.

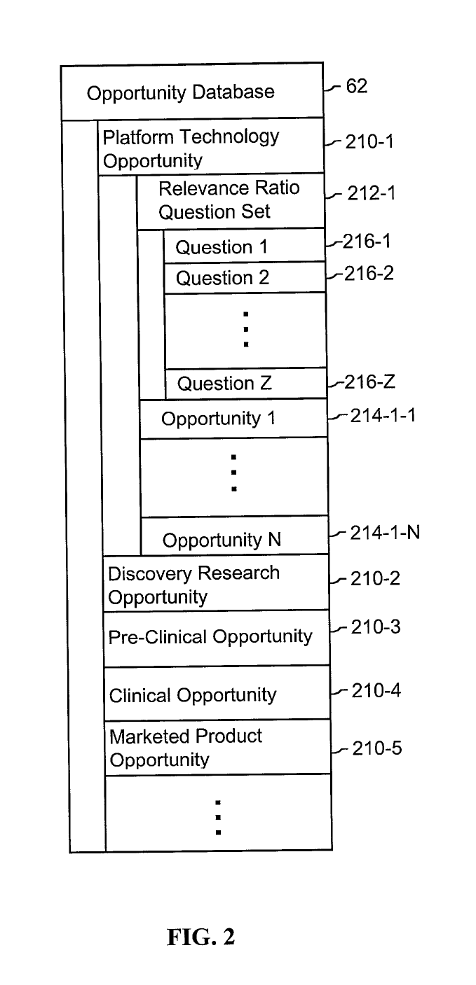

Database 60 includes an Opportunity Database 62, a Buyer Database 64, and a Seller Database 66. The Opportunity Database contains entries for each life sciences opportunity that is posted on server 24. In the preferred embodiment, the life sciences opportunities are subdivided into opportunity types where each opportunity type represents a life sciences category. In this embodiment, Opportunity Database 62 contains an entry 210 for each opportunity type (See FIG. 2). Preferably, the life sciences opportunities are classified into the following opportunity types: Platform Technology, Discovery Research, Pre-clinical, Clinical, and Marketed Product.

For each seller 68 stored in database 66, Seller Database 66 includes entries for seller Profile 70 which contains general information about the seller, the seller's Contact Information 72, the seller's Financial Information 74, and the seller's Priorities 76. Priorities 76 are the seller's preferences for each opportunity type. Seller priorities 76 contain the seller's responses to each question in the Relevance Ratio question set 212 (FIG. 2) for each opportunity type 210 (FIG. 2). In the preferred embodiment the seller's responses are selected from “Yes”, “No”, or “N/A.”

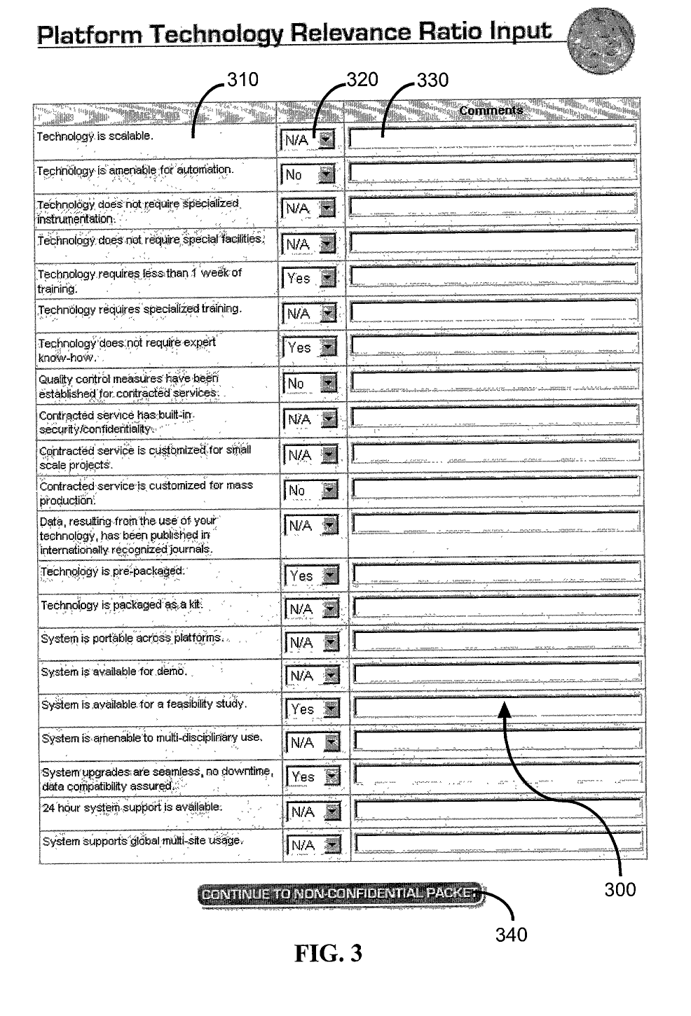

The Relevance Ratio question set comprises a standardized list of technical questions and is used to assess each opportunity that matches the buyer's search criteria. The standardized list of technical questions contains questions that a typical buyer would ask when evaluating a life sciences opportunity. For example, a typical buyer searching for a clinical opportunity would want to know whether the minimum efficacious dosage has been established or whether toxicity studies have been completed. The relevance ratio indicates the extent to which the seller considered the standardized list of technical questions applicable to the posted opportunity and allows a buyer to quickly assess the quality and depth of development of a life sciences opportunity. The processing steps associated with generating a relevance ratio are described in greater detail below. FIG. 3 illustrates an exemplary list of standardized technical questions for the platform technology opportunity type.

Typically, the Relevance Ratio question set for each opportunity type contains a unique set of technical questions. Thus, the Relevance Ratio question set for the platform technology opportunity type contains a different set of questions than the Relevance Ratio question set for marketed product opportunity type. However, those skilled in the art will appreciate that two opportunity types may contain the same set of technical questions.

A seller master user is an authorized seller representative who may post, edit, review, or suspend the seller's opportunities. The seller master user indicates whether the seller considers the list of technical questions applicable to the posted opportunity by providing responses to the Relevance Ratio question set for each opportunity type. In one embodiment, application server 52 provides default responses to the Relevance Ratio question set 212 (FIG. 2). In the preferred embodiment, the master user can modify the default responses. In another embodiment, access to the seller's responses 76 is protected by a password, and only authorized seller representatives may edit the seller's responses.

Similarly, a buyer master user is an authorized company representative who indicates the company's priorities by providing responses to the Relevance Ratio question set for each opportunity type. In one embodiment, application server 52 provides default responses to Relevance Ratio question set 212 (FIG. 2). In the preferred embodiment, the buyer master user can modify the default responses. In another embodiment, access to the company's responses 76 is protected by a password, and only authorized buyer representatives may edit the buyer's responses.

FIG. 2 illustrates an opportunity data structure in accordance with an embodiment of the invention. Each opportunity type 210 in Opportunity Database 62 includes an entry 212 which contains a Relevance Ratio question set for that opportunity type. Opportunity database 62 further contains entries 214 for each opportunity posted for opportunity type 210. The Relevance Ratio question set contains technical questions 216 designed to provide a buyer with information about a life sciences opportunity that a buyer would consider relevant when assessing the life sciences opportunity.

FIG. 3 illustrates a graphical user interface (GUI) of an exemplary Relevance Ratio question set for an opportunity type in accordance with an embodiment of the invention. Each opportunity type contains a different set of questions such that the questions in each opportunity type address the typical buyer's requirements for that opportunity type. The GUI shown in FIG. 3 displays a Relevance Ratio question set for the Platform Technology Opportunity type. The GUI contains the Relevance Ratio questions 310, the seller responses 320 to each question 310, and the seller's comments 330 for each question 310.

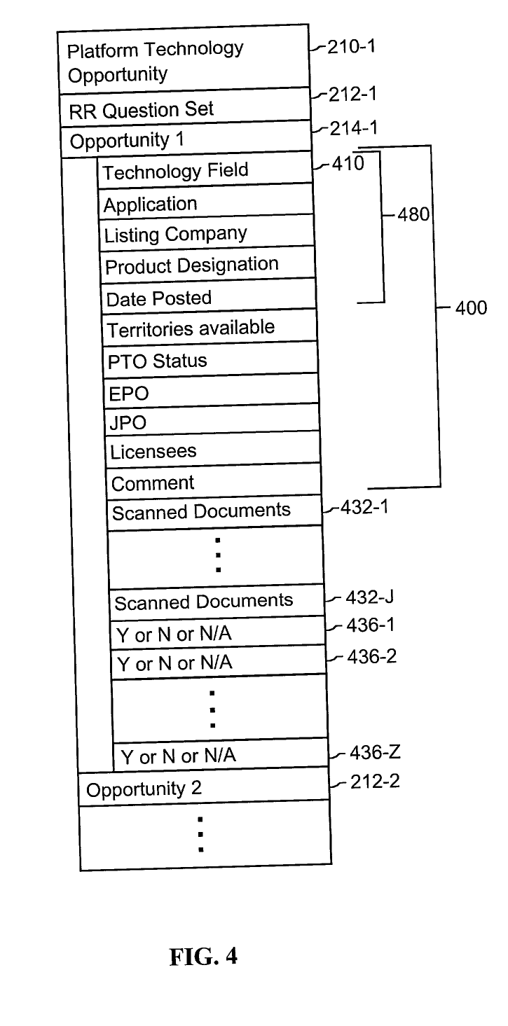

FIG. 4 illustrates an opportunity type data structure in accordance with an embodiment of the invention. For each opportunity 214, Opportunity Database 62 (FIGS. 1 and 2) contains characteristic entries 400 which store the opportunity characteristics. Database 62 also contains entries 436 for each opportunity 214 which contain the seller's responses to each question in the Relevance Ratio question set 212 for that opportunity type.

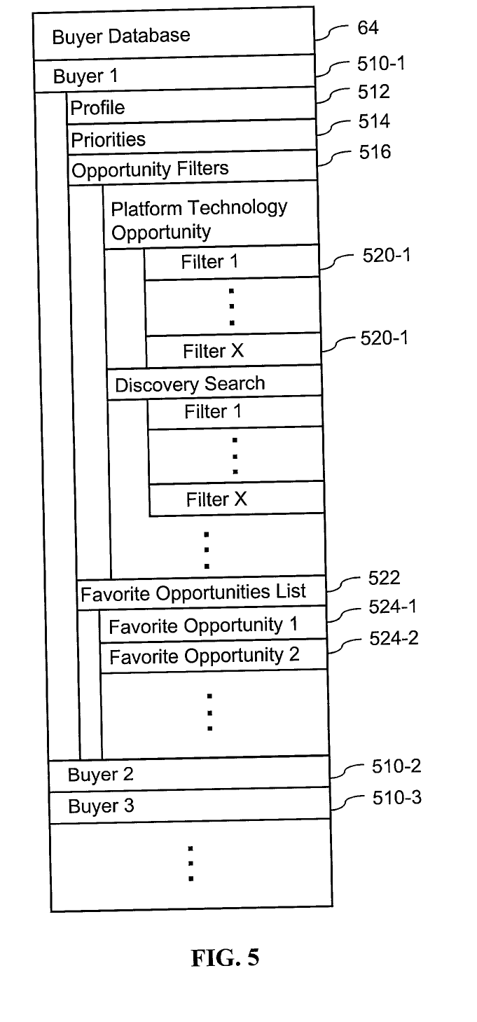

FIG. 5 illustrates a data structure for storing buyer information in accordance with an embodiment of the invention. Buyer database 64 contains information about users who search for life sciences opportunities in opportunity database 62 (FIG. 1). For each buyer 510, buyer database 64 includes the buyer's personal Profile 512 and the buyer's Priorities 514. The buyer's personal profile contains general information about the buyer and the buyer contact information. Buyer priorities 514 contain the buyer's responses to the Relevance Ratio question set for each opportunity type 210 (FIG. 2) in Opportunity Database 60 (FIG. 1). Preferably, the buyer's responses are selected from “Yes” or “No.”

Buyer Database 64 further includes the buyer's Opportunity Filters 516 and the buyer's Favorite Opportunities List 522. Opportunity filters 516 store one or more filters 520 containing the buyer's search criteria for each opportunity type. Thus, a buyer need not enter the search criteria each time the buyer searches for opportunities matching a particular saved search criteria.

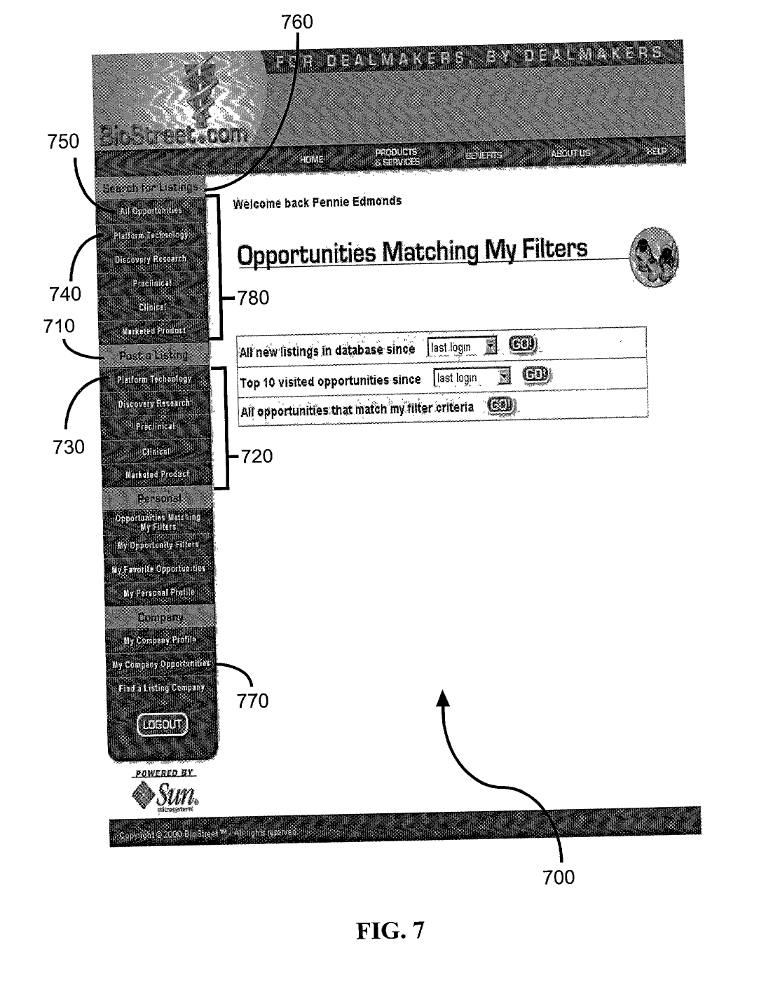

Favorite Opportunities List 522 contains opportunities 524 that a buyer has saved after conducting a search. The buyer can subsequently view opportunities 524 without conducting a new search by viewing the saved favorite opportunities without conducting a search. In an alternative embodiment, the buyer's Priorities (as explained in relation to FIG. 7), Opportunity Filters, and Favorite Opportunities List are stored on client 22.

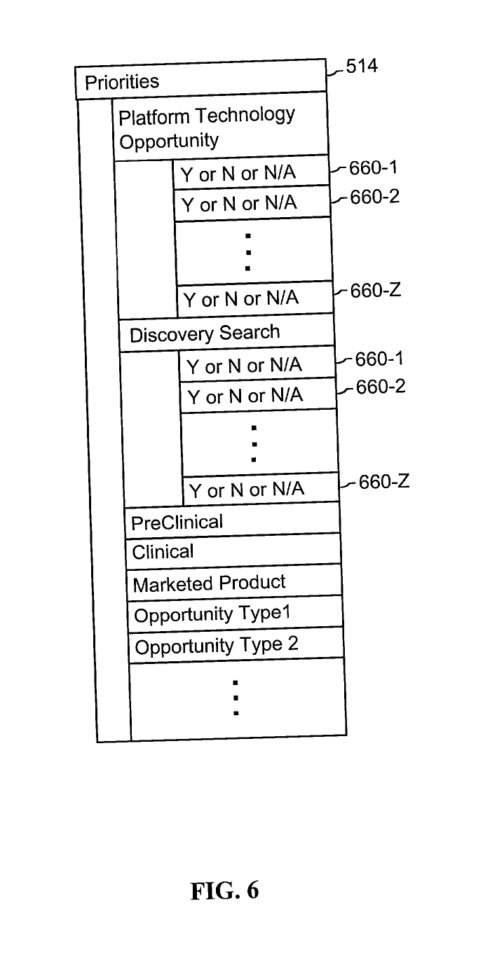

FIG. 6 illustrates a data structure for storing a buyer's preferences in accordance with an embodiment of the invention. Priorities 514 contain the buyer's preferences for each opportunity type 210 (FIG. 2) in Opportunity Database 62 (FIG. 2). The buyer indicates these preferences by providing responses 660 to the Relevance Ratio question set 212 (FIG. 2) for each opportunity type.

In one embodiment, the buyer further provides a weight for each question in the Relevance Ratio question set. In this embodiment, the buyer for example provides a number that indicates the relevance of the particular question to the buyer. Illustratively, in the Platform Technology Relevance Ratio question set shown in FIG. 3, a buyer provides a number between one and ten to indicate the relevance of each question to the buyer. A buyer who wants a technology that is scalable may select the number ten for the first question to indicate the importance of scalability to the buyer. The same buyer will select, for example the number five for the second question, if automation of the technology is not as important to the buyer. The system then generates a weighted first sum and a weighted second sum for a matched opportunity.

In the preferred embodiment, the application server provides default responses to the Relevance Ratio question set. In this embodiment, the buyer can subsequently modify the default responses.

FIG. 7 illustrates a GUI used for performing various tasks in accordance with an embodiment of the invention. A seller posts an opportunity by selecting an opportunity type by clicking on a button 720 from the “Post a Listing” menu 710, e.g., a seller can post a platform technology opportunity by clicking on button 730.

A buyer uses GUI 700 to search for opportunities in Opportunity Database 62 (FIG. 1). A buyer can search for opportunities in a particular opportunity type by clicking on the corresponding button in “Search for Listings” menu 780. For example, a buyer can search for opportunities in platform technology by clicking on the “Platform Technology” button 740. Alternatively, a buyer can search all opportunities stored in Opportunity Database 62 (FIG. 1) by clicking on the “All Opportunities” button 750.

Posting a Life Sciences Opportunity

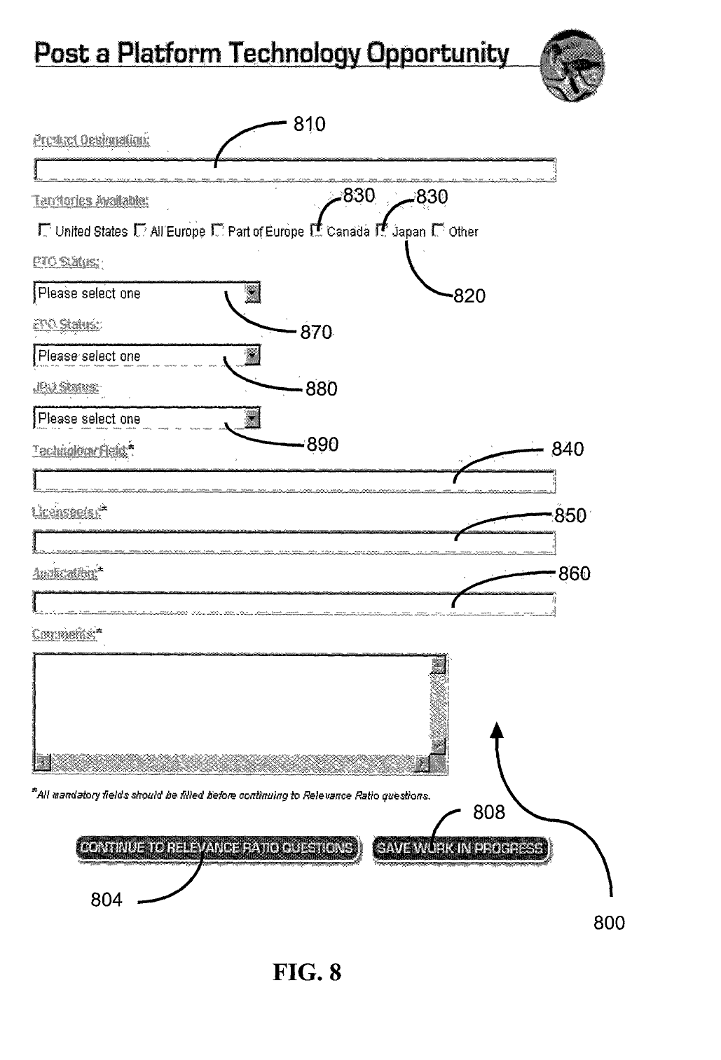

FIG. 8 illustrates a GUI used for posting opportunities in accordance with an embodiment of the invention. For example, the seller provides information about the platform technology opportunity by completing the standardized list of characteristic entries in the “Post a Platform Technology Opportunity” web page. The seller provides the product name or identification number in field 810. The seller further selects geographical territories in which the seller is seeking a partner for the opportunity by toggling check boxes 830 corresponding to the appropriate geographical territory 820. In the preferred embodiment, the available geographical territories include the United States, All Europe, Part of Europe, Canada, Japan, and Other. Additionally, the seller provides the general categorical term, e.g., microarray or drug delivery, that describes the technology in field 840, licensees in field 850 and product application in field 860.

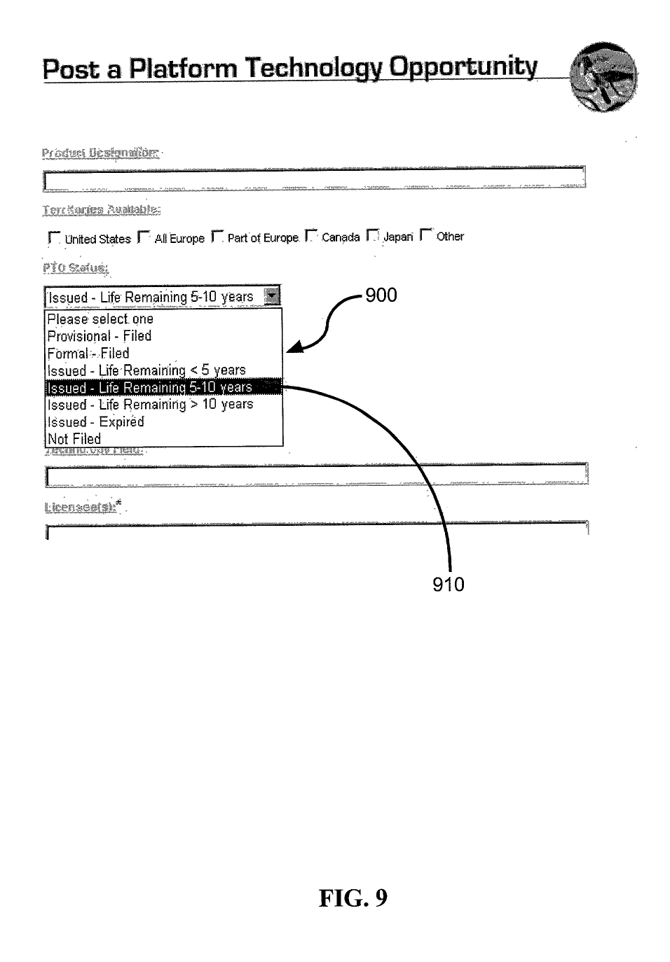

The seller further provides the intellectual property status of the opportunity. The intellectual property status of an opportunity includes information relating to the opportunity's patent status. For example, the seller can indicate whether the opportunity is patented, and, if so, the status of the patent, i.e. whether the patent is in force, abandoned, or expired. The seller can also indicate whether a patent has been filed for the opportunity. In the preferred embodiment, the seller provides the status of the opportunity in the United States Patent and Trademark Office (USPTO) 870, in the European Patent Office (EPO) 880, and in the Japanese Patent Office (JPO) 890 by selecting the appropriate status 910 (See FIG. 9) from the drop down menu 900 for the PTO, EPO, and JPO fields.

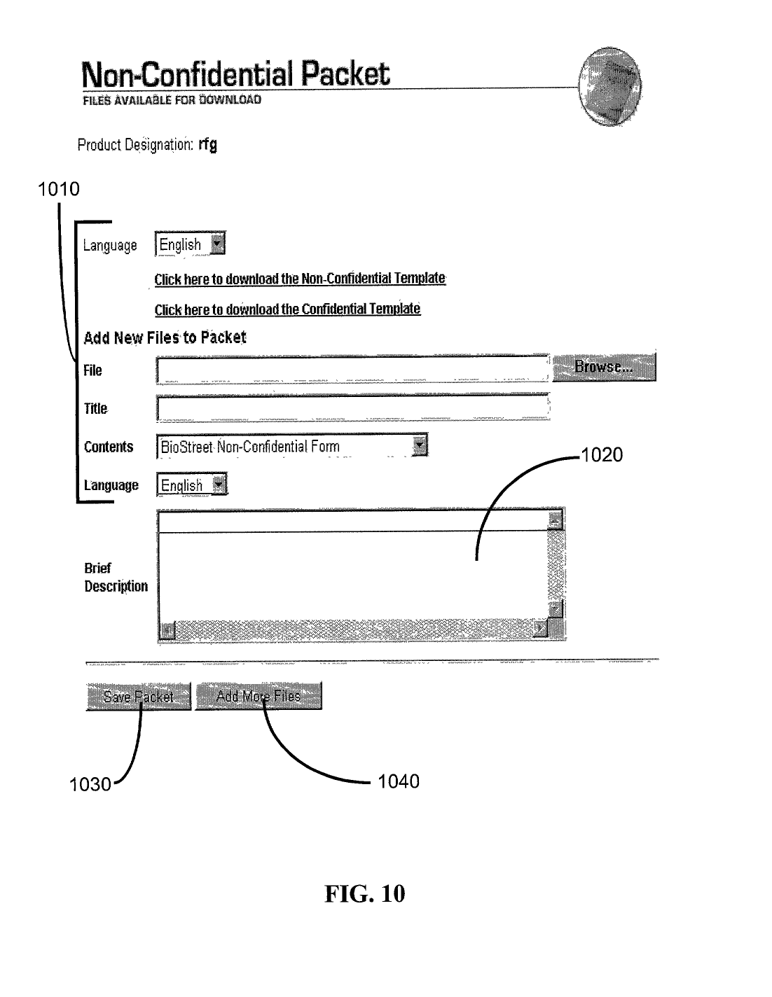

FIG. 10 illustrates a GUI for uploading information packets for an opportunity in accordance with an embodiment of the invention. The information packet provides additional information about the posted opportunity and optionally includes confidential information, such as a non-disclosure agreement, and non-confidential information. The non-confidential information can be an executive summary, a technology overview, additional data or studies conducted. The seller completes fields 1010, provides a brief description of the document in field 1020, and may scan in a document described in field 1020. The seller may upload additional documents by clicking on the “Add More Files” button 1040. Once the files are uploaded, the information packet is saved by clicking on “Save Packet” button 1030.

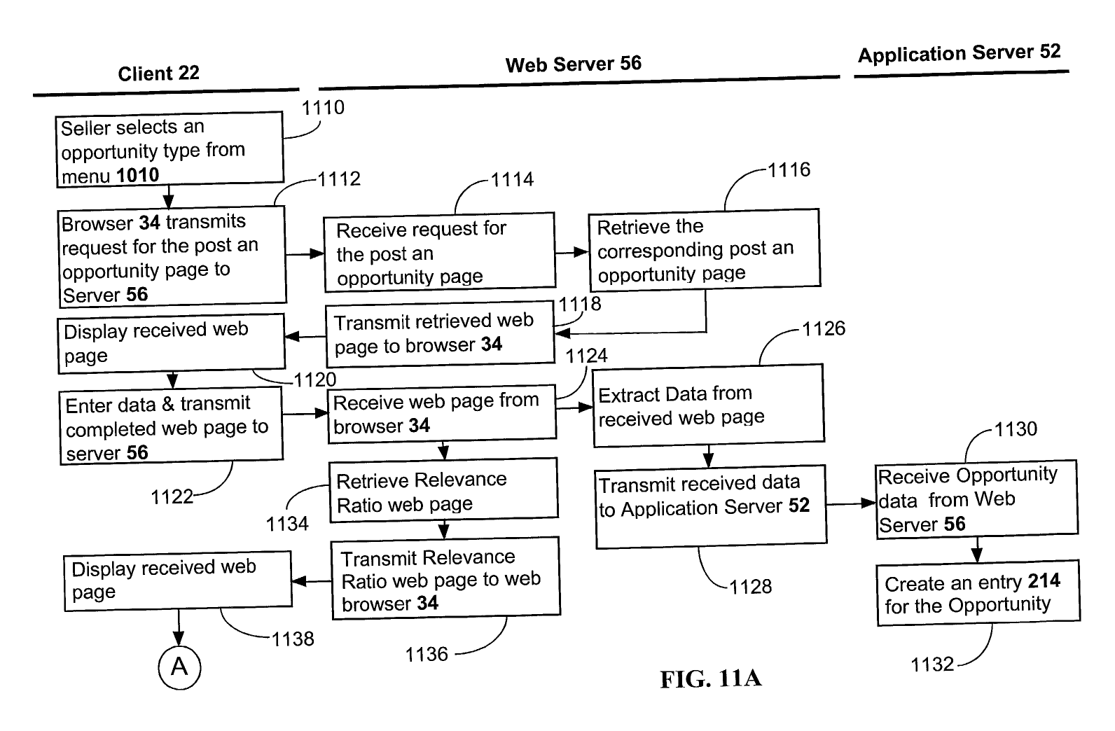

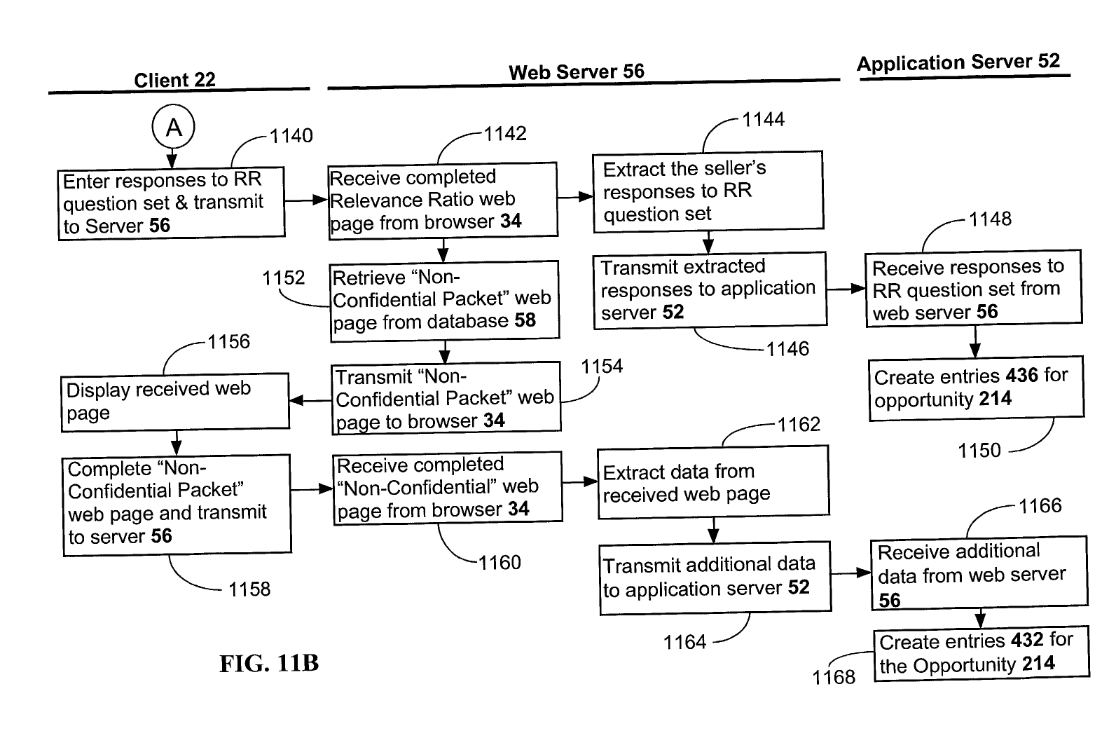

This brief description of one aspect of the invention will be more clearly understood by reference to FIGS. 11A and 11B which illustrate the processing steps performed when posting an opportunity in accordance with an embodiment of the invention.

A seller posts an opportunity by selecting (Step 1110) an opportunity type, for example by clicking on a button 720 (FIG. 7) from “Post a Listing” menu 710. When a seller clicks on an opportunity type button 720, browser 34 (FIG. 1) transmits (Step 1112) a request for the corresponding post an opportunity web page to web server 56.

Web server 56 (FIG. 1) receives (Step 1114) the web page request from browser 34 and subsequently retrieves (Step 1116) the requested web page from web page database 58 (FIG. 1). Web server 56 then transmits (Step 1118) the requested web page to browser 34 (FIG. 1) via network 26. Browser 34 displays (Step 1120) the requested web page on input/output device 38. The seller provides the opportunity characteristics by completing (Step 1122) the entries in the post an opportunity web page.

Illustratively, a seller can post (Step 1110) a Platform Technology opportunity by selecting “Platform Technology” 730 (FIG. 7) from the “Post a Listing” menu 710 (FIG. 7). Browser 34 (FIG. 1) transmits (Step 1112) a request for the “Post a Platform Technology Opportunity” web page to web server 56 (FIG. 1). Web server 56 (FIG. 1) receives (Step 1114) the request for “Post a Platform Technology Opportunity” web page and retrieves (Step 1116) the requested web page. Web server 56 (FIG. 1) then transmits the requested web page to browser 34 (Step 1118), which then displays (Step 1120) the web page on input/output device 38.

After completing the entries in the post an opportunity web page 800 (FIG. 8), the seller continues to the Relevance Ratio question set by clicking on the “Continue to Relevance Ratio Questions” button 804 (FIG. 8). The seller also has the option of saving the entered information and returning to it at a later time by clicking on the “Save Work in Progress” button 808. A seller can preferably save the entered information at any time during the data entry process.

When the seller clicks on the “Continue to Relevance Ratio Questions” button 804 (FIG. 8), browser 34 (FIG. 1) transmits (Step 1122) the completed post an opportunity web page to web server 56 (FIG. 1). Web server 56 receives (Step 1124) the completed web page and extracts (Step 1126) the entered data from the completed web page. Web server 56 (FIG. 1) extracts the entered data using one of the many well known techniques in the art for extracting entered information from a web page. Web server 56 then transmits (Step 1128) the extracted data to application server 52 (FIG. 1).

Application server 52 (FIG. 1) receives (Step 1130) the opportunity data from web server 56 (FIG. 1) and creates (Step 1132) an entry 214 (FIG. 2) in opportunity database 62 (FIG. 1) under the selected opportunity type. For example, for a seller posting a Platform Technology opportunity, application server 52 (FIG. 1) creates an entry 214-1-X (FIG. 2) in the Platform Technology opportunity database 210-1 (FIG. 2).

Server 56 (FIG. 1) further retrieves (Step 1134) the Relevance Ratio web page for the selected opportunity type from web page database 58 (FIG. 1) and transmits (Step 1136) the Relevance Ratio web page to browser 34 (FIG. 1) via network 26. Browser 34 (FIG. 1) subsequently displays (Step 1138) the Relevance Ratio web page on input/output device 38 (FIG. 1).

After providing responses to the Relevance Ratio question set (FIG. 9B, Step 1140), the seller uploads additional information about the opportunity by clicking on the “Continue to Non-Confidential Packet” button 340 on web page 300 (FIG. 3). When the seller clicks on the “Continue to Non-Confidential Packet” button, browser 34 (FIG. 1) transmits the completed Relevance Ratio web page to web server 56 (Step 1140) (FIG. 1).

Web server 56 (FIG. 1) receives (Step 1142) the completed Relevance Ratio web page, extracts (Step 1144) the seller's responses to the Relevance Ratio question set from the Relevance Ratio web page, and transmits (Step 1146) the extracted responses to application server 52 (FIG. 1). Application server 52 receives (Step 1148) the seller's responses to the Relevance Ratio question set and creates (Step 1150) entries 436 (FIG. 4) which store the seller's responses to the Relevance Ratio question set for the posted opportunity.

Web server 56 (FIG. 1) further retrieves (Step 1152) the “Non-Confidential Packet” web page and transmits (Step 1154) the retrieved web page to browser 34 (FIG. 1) which then displays (Step 1156) the web page on input/output device 38 (FIG. 1).

After the seller has uploaded all additional documents, the seller saves the additional information packet by clicking on the “Save Packet” button 1030 (FIG. 10). The additional information packet contains additional data, such as for example financial information or test results, that the seller provides when posting an opportunity on system 20. In one embodiment, the additional information is numerical data, images, text, or a combination of text, images, and numerical data. Browser 34 (FIG. 1) transmits (Step 1158) the completed “Non-Confidential Packet” web page to web server 56 (FIG. 1). Web server 56 receives (Step 1160) the completed “Non-Confidential Packet” web page, extracts (Step 1162) the additional data from the received web page, and transmits (Step 1164) the extracted data to application server 52 (FIG. 1).

Application server 52 receives (Step 1166) the uploaded information and creates (Step 1168) entries 432 (FIG. 4) which store the uploaded information for the posted opportunity. In the preferred embodiment, the information provided by a seller is reviewed and audited by a life sciences opportunity service provider. The life sciences opportunity service provider further reviews the data to ensure that the data conforms to a standardized format before the opportunity is posted in the opportunity database.

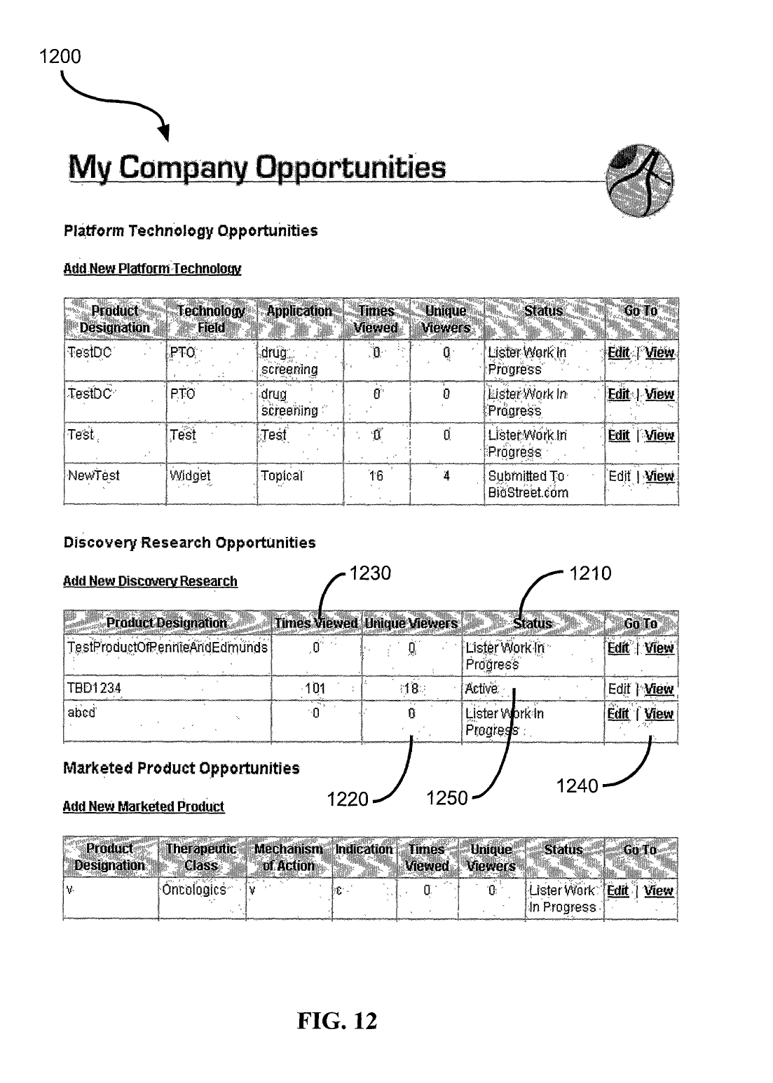

FIG. 12 illustrates a GUI posting a company's opportunities in accordance with an embodiment of the invention. Once the seller has posted an opportunity, the seller may edit, review, or suspend the posted opportunity by clicking on the corresponding button 1240 on the “My Company Opportunities” web page 1200. A seller views its opportunities by clicking on “My Company Opportunities” button 770 (FIG. 7).

The “My Company Opportunities” web page 1200 displays all seller opportunities that are currently posted, all seller opportunities that are suspended, and all seller opportunities that are being prepared for posting. When the seller suspends an opportunity, the application server does not transmit information about that opportunity to potential buyers. Thus, a buyer cannot view the suspended opportunity. In the preferred embodiment, the editing or suspension of an opportunity requires that a user provide identifying information before the user can edit or suspend a posted opportunity. Preferably, an opportunity service provider reviews and audits the edited opportunity prior to posting the edited opportunity in the opportunity database.

In the embodiment shown, the seller opportunities are listed by opportunity type. For each seller opportunity, the web page provides the status of the opportunity 1210, the number of viewers who have visited the opportunity 1220, and the number of times the opportunity has been viewed 1230.

Searching for Opportunities

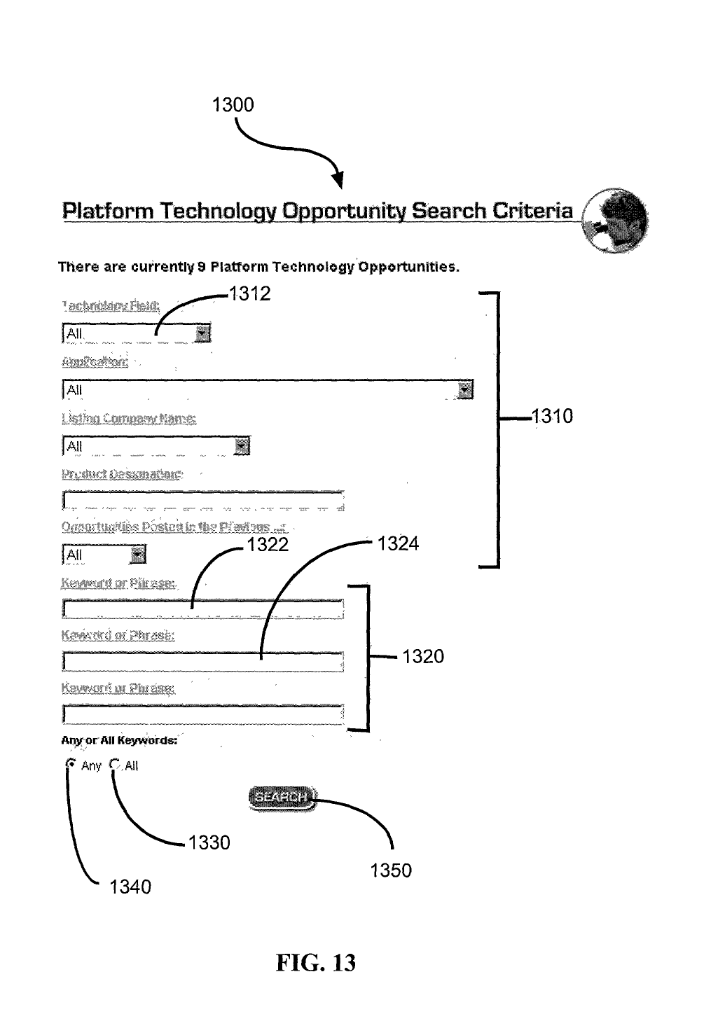

FIG. 13 illustrates a GUI for entering a buyer's search criteria in accordance with an embodiment of the invention. The buyer enters a search criteria for an opportunity by completing one or more fields 1310. A buyer further narrows or expands a search by providing specific keywords or phrases in fields 1320. The buyer searches for opportunities that contain all keywords or phrases entered in search fields 1320 by toggling the “All” button 1330. Alternatively, the buyer searches for opportunities that contain any of the keywords or phrases in search fields 1320 by toggling the “Any” button 1340.

Illustratively, a buyer specifies “angiogenesis” in search field 1322 and “anti-B-cell radioimmunotherapy” in search field 1324. The buyer then searches for all opportunities that contain either “angiogenesis” or “anti-B-cell radioimmunotherapy” by clicking on button 1340. Or, the buyer can search for all opportunities that contain both “angiogenesis” and “anti-B-cell radioimmunotherapy” by clicking on button 1330.

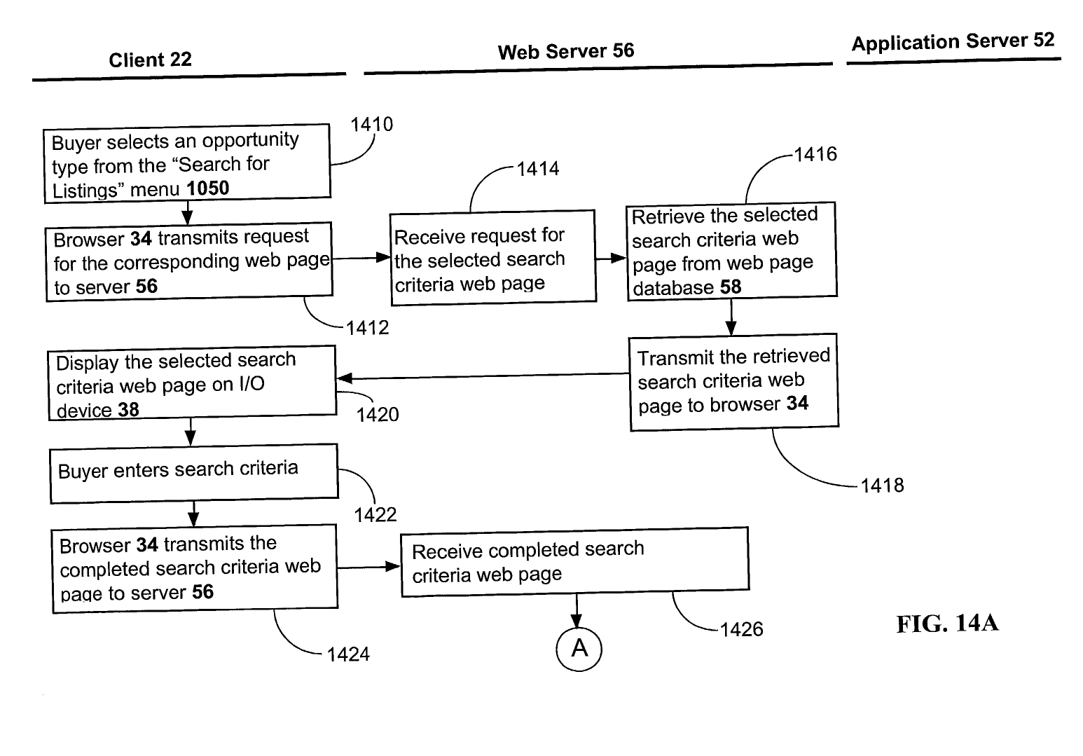

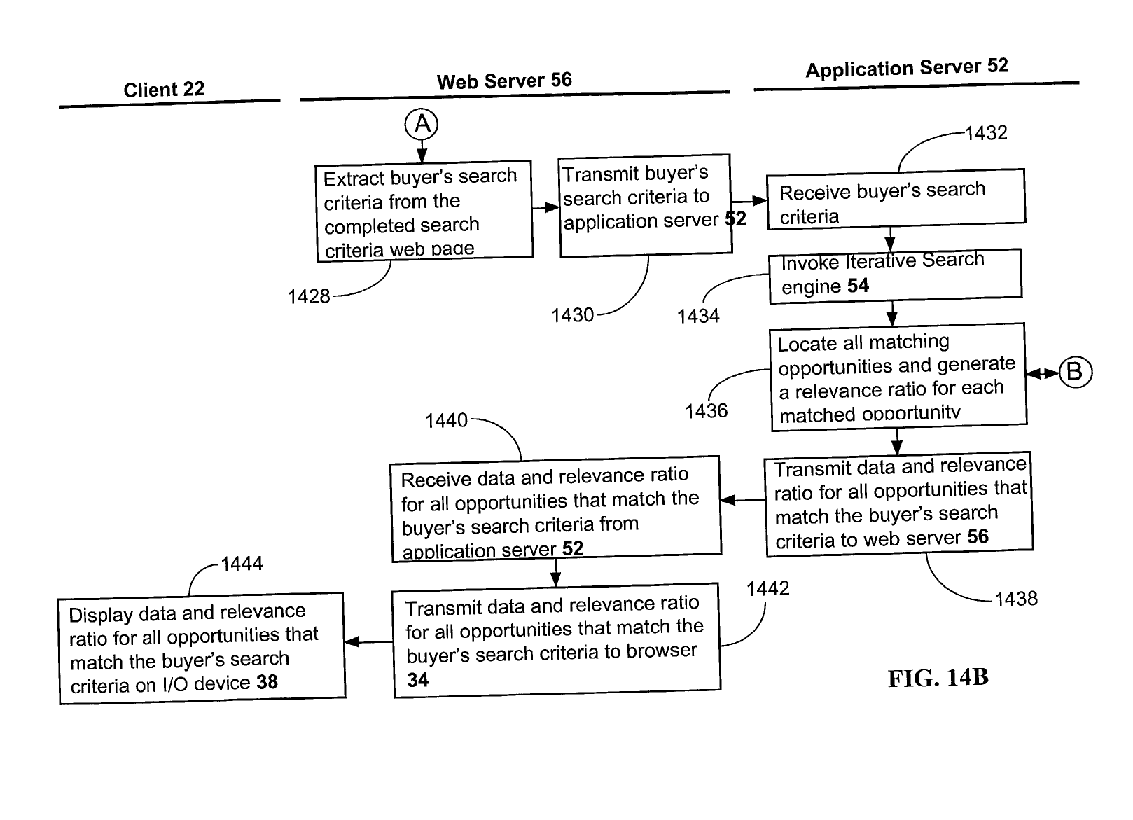

FIGS. 14A and 14B illustrate the processing steps performed when searching for opportunities in accordance with an embodiment of the invention. A buyer searches for available opportunities by clicking on a button 780 (FIG. 7) in the “Search for Listings” menu 760 (FIG. 7). When the buyer clicks (Step 1410) on a button 780 (FIG. 7), browser 34 (FIG. 1) transmits (Step 1412) a request for the corresponding web page to web server 56 (FIG. 1). Upon receiving (Step 1414) the request from browser 34, web server 56 retrieves (Step 1416) the requested web page from web page database 58 (FIG. 1). Web server 56 transmits (Step 1418) the requested web page to browser 34 via network 26. Browser 34 then displays (Step 1420) the requested web page on input/output device 38 (FIG. 1). The buyer provides (Step 1422) the search criteria by completing one or more fields 1310 and 1320 (FIG. 13).

After the buyer has provided the search criteria, the buyer submits the search by clicking on the “SEARCH” button 1350 (FIG. 13). Browser 34 (FIG. 1) transmits (Step 1424) the completed search criteria web page to web server 56 (FIG. 1). Web server 56 receives (Step 1426) the buyer's completed search criteria web page, extracts (FIG. 14B, Step 1428) the search criteria from the completed web page, and transmits (Step 1430) the extracted search criteria to application server 52 (FIG. 1).

Application server 52 receives (Step 1432) the buyer's search criteria and invokes (Step 1434) iterative search engine 54 (FIG. 1). Iterative search engine 54 locates (Step 1436) all opportunities that match the buyer's search criteria and generates (Step 1436) a relevance ratio for the matched opportunity. The processing steps performed by iterative search engine 54 are described in greater detail below.

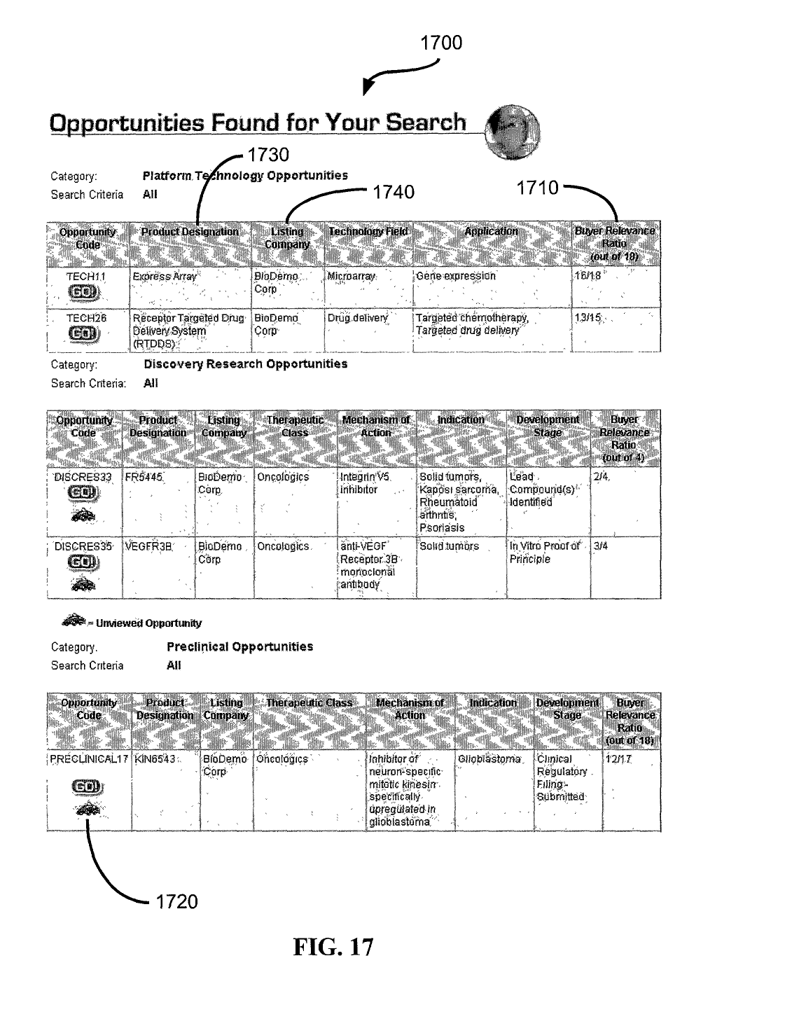

Application server 52 (FIG. 1) transmits (Step 1438) the matched opportunity data including the relevance ratio to web server 56 (FIG. 1). Web server 56 receives (Step 1440) the opportunity data and relevance ratio for the matched opportunity and transmits (Step 1442) the received data to browser 34 (FIG. 1) via network 26. Browser 34 subsequently displays (Step 1444) the result on input/output device 38 (FIG. 1). An exemplary search results web page is shown in FIG. 17.

In other embodiments, the iterative search engine stores the matched opportunity data in a temporary memory until the search engine has found all opportunities that match the buyer's criteria. In this embodiment, the iterative search engine transmits all opportunities matching the buyer's criteria after the search engine has found all opportunities that match the buyer's search criteria.

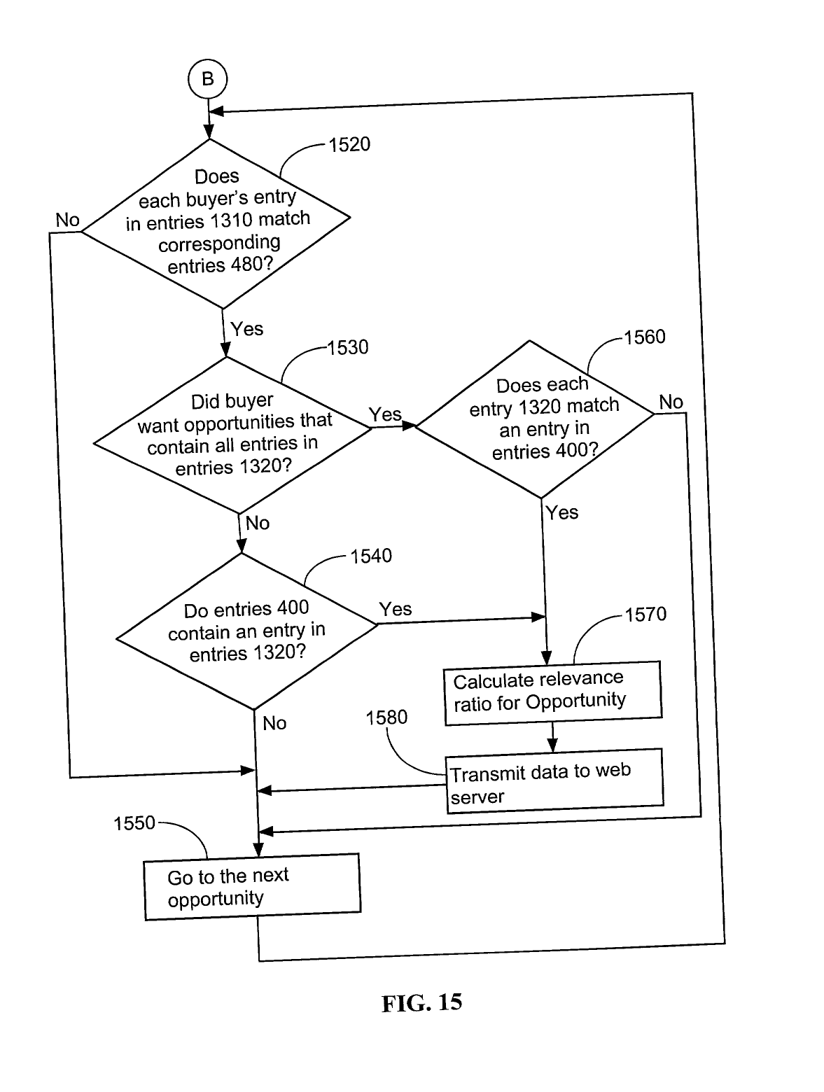

FIG. 15 illustrates the processing steps performed by iterative search 54 when searching for opportunities in accordance with an embodiment of the invention. Iterative search engine 54 (FIG. 1) finds all opportunities matching the buyer's search criteria by comparing (Step 1520) the buyer's entries in search criteria fields 1310 (FIG. 13) with the seller's responses in corresponding entries 480 (FIG. 4) in opportunity 212 (FIG. 1) for the selected opportunity type.

For example, if the buyer provided a search term in the “Technology Field” search field 1312 (FIG. 13), the iterative search engine will compare the entry in search field 1312 (FIG. 13) with entry 410 (FIG. 4) for opportunity 212 (FIG. 2) listed in Platform Technology Opportunity database 210 (FIG. 2). If no entry in platform technology search fields 1310 (FIG. 13) matches (Step 1520-No) the corresponding entry in opportunity 212, iterative search engine 54 (FIG. 1) then searches (Step 1550) the next opportunity in Platform Technology Opportunity database 210-1 (FIG. 2).

If each entry in platform technology search fields 1310 (FIG. 13) matches (Step 1520-Yes) the corresponding entry in opportunity 212, iterative search engine 54 next compares the entries in keywords or phrase search fields 1320 (FIG. 13) with characteristic entries 400 (FIG. 4) for the opportunity. If the buyer is seeking opportunities that contain (Step 1530-Yes) all keywords or phrases entered in keywords or phrase search fields 1320 (FIG. 13) and if a keyword or phrase in search fields 1320 (FIG. 13) does not match (Step 1560-No) an entry in characteristic entries 400, the iterative search engine then searches (Step 1550) the next opportunity in Opportunity database 60 (FIG. 1).

If all keywords or phrases entered in keyword search fields 1320 match (Step 1560-Yes) an entry in characteristic entries 400 (FIG. 4), iterative search engine 54 (FIG. 1) next generates (Step 1570) a relevance ratio for that opportunity. The processing steps for generating the relevance ratio are described in greater detail below. Iterative search engine 54 (FIG. 1) then transmits (Step 1580) data for the matched opportunity, including the relevance ratio, to application server 52 (FIG. 1). Iterative search engine 54 (FIG. 1) then searches (Step 1550) the next opportunity in Opportunity database 60 (FIG. 2).

Returning to Step 1530, if the buyer wants (Step 1530-No) opportunities that contain any of the keywords or phrases entered in keyword or phrase search fields 1320 (FIG. 13) and if none of the keywords or phrases entered in search fields 1320 (FIG. 13) matches (Step 1540-No) an entry in characteristic entries 400 (FIG. 4), iterative search engine 54 (FIG. 1) then searches (Step 1550) the next opportunity 212 (FIG. 2) in Opportunity database 60 (FIG. 1).

If at least one of the keywords or phrases entered in search fields 1320 (FIG. 13) matches (Step 1540-Yes) an entry in characteristic entries 400 (FIG. 4), iterative search engine 54 (FIG. 1) then generates (Step 1570) a relevance ratio for that opportunity. The processing steps for generating a relevance ratio are discussed in greater detail below. Iterative search engine 54 (FIG. 1) then transmits (Step 1580) the data for the matched opportunity, including the relevance ratio, to application server 52 (FIG. 1). Iterative search engine 54 (FIG. 1) then searches (Step 1550) the next opportunity 212 (FIG. 1) in Opportunity database 60 (FIG. 1).

Generating a Relevance Ratio

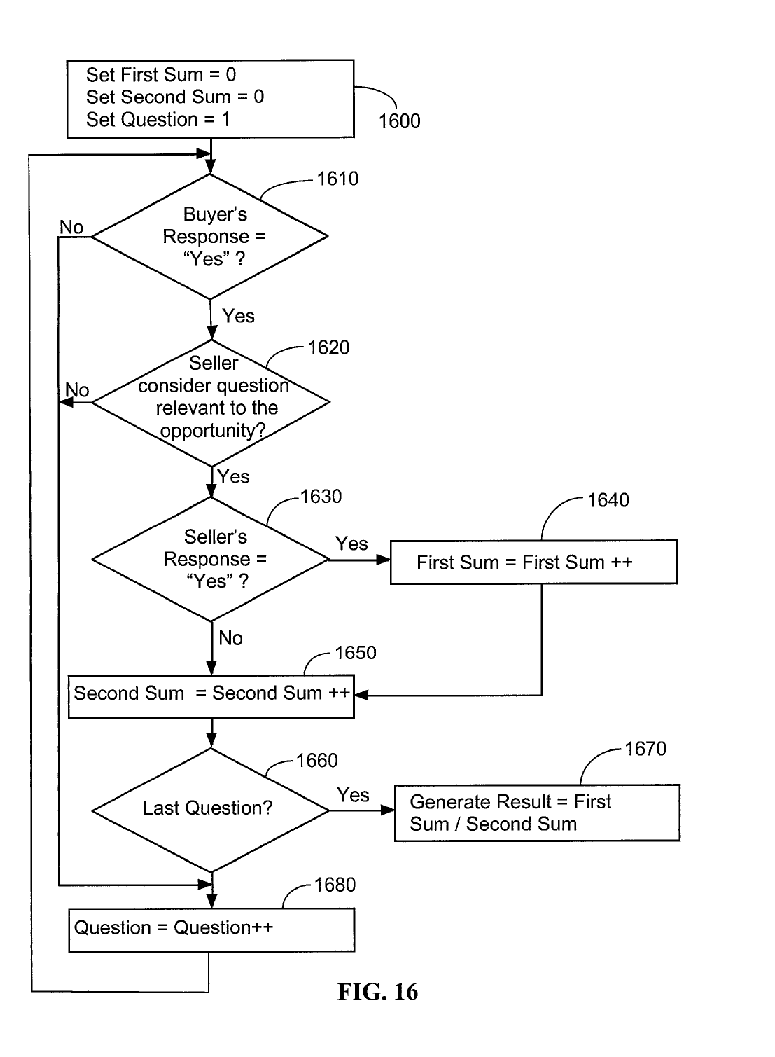

FIG. 16 illustrates the processing steps performed in generating a relevance ratio in accordance with an embodiment of the invention. Application server 52 (FIG. 1) generates a relevance ratio for each opportunity that matches the buyer's search criteria. To generate the relevance ratio, server 52 (FIG. 1) compares the buyer's responses 660 (FIG. 6) to the Relevance Ratio question set 212 (FIG. 2) against the seller's responses 436 (FIG. 4) to the Relevance Ratio question set 212 (FIG. 2). FIG. 3 illustrates a Relevance Ratio question set for the platform technology life sciences opportunity type.

Server 52 sets (Step 1600) the initial values for the First Sum, the Second Sum, and the Question parameters. In the preferred embodiment, the values for First Sum, Second Sum, and Question are set to zero, zero, and one, respectively. The First Sum is equal to the number of all questions that both the buyer and the seller consider as relevant to the opportunity and to which both the buyer and the seller provide a “Yes” response. The Second Sum is equal to the number of all questions to which the buyer provided a first response and which the seller considered as relevant to the opportunity. The Question represents the question number in the sequence of technical questions in the Relevance Ratio question set for an opportunity type.

First, server 52 (FIG. 1) determines (Step 1610) if a question is relevant to the buyer. In the preferred embodiment, the question is relevant to the buyer if the buyer's response to the question is “Yes.” If the question is not relevant to the buyer (Step 1610-No), server 52 (FIG. 1) next determines (Step 1660) if the question is the last question in the Relevance Ratio question set. If the question is not (Step 1660-No) the last question in the Relevance Ratio question set, server 52 (FIG. 1) proceeds (Step 1680) to the next question in the Relevance Ratio question set and repeats Steps 1610 through 1650 until it reaches the last question in the relevance ratio question set for the opportunity type.

If the question is relevant (Step 1610-Yes) to the buyer, server 52 (FIG. 1) determines (Step 1620) if the seller considers the question relevant to the posted opportunity. Preferably, a seller considers a question relevant to the posted opportunity if the seller's response to the question is either “Yes” or “No”.

If the seller considers (Step 1620-Yes) the question relevant to the posted opportunity and the seller's response to the question is “Yes” (Step 1630-Yes), server 52 (FIG. 1) increases (Step 1640) First Sum by one and server 52 (FIG. 1) increases (Step 1650) Second Sum by one. Server 52 (FIG. 1) next determines (Step 1660) if the question is the last question in the Relevance Ratio question set. If the question is not (Step 1660-No) the last question in the Relevance Ratio question set, server 52 (FIG. 1) proceeds (Step 1680) to the next question in the Relevance Ratio question set and repeats Steps 1610 through 1650 until it reaches the last question in the relevance ratio question set for the opportunity type.

Going back to Step 1630, if the seller's response to the question is not “Yes” (Step 1630-No), then server 52 (FIG. 1) increases only the Second Sum by one (Step 1650) and does not increase the First Sum. Server 52 (FIG. 1) next determines (Step 1660) if the question is the last question in the Relevance Ratio question set. If the question is not (Step 1660-No) the last question in the Relevance Ratio question set, server 52 (FIG. 1) proceeds (Step 1680) to the next question in the Relevance Ratio question set and repeats Steps 1610 through 1650 until it reaches the last question in the Relevance Ratio question set for the opportunity type.

Returning to Step 1620, if the seller does not consider (Step 1620-No) the question relevant to the opportunity, then server 52 (FIG. 1) determines (Step 1660) if the question is the last question in the Relevance Ratio question set. If the question is not (Step 1660-No) the last question in the Relevance Ratio question set, server 52 (FIG. 1) proceeds (Step 1680) to the next question in the Relevance Ratio question set and repeats Steps 1610 through 1650 until it reaches the last question in the relevance ratio question set for the opportunity type.

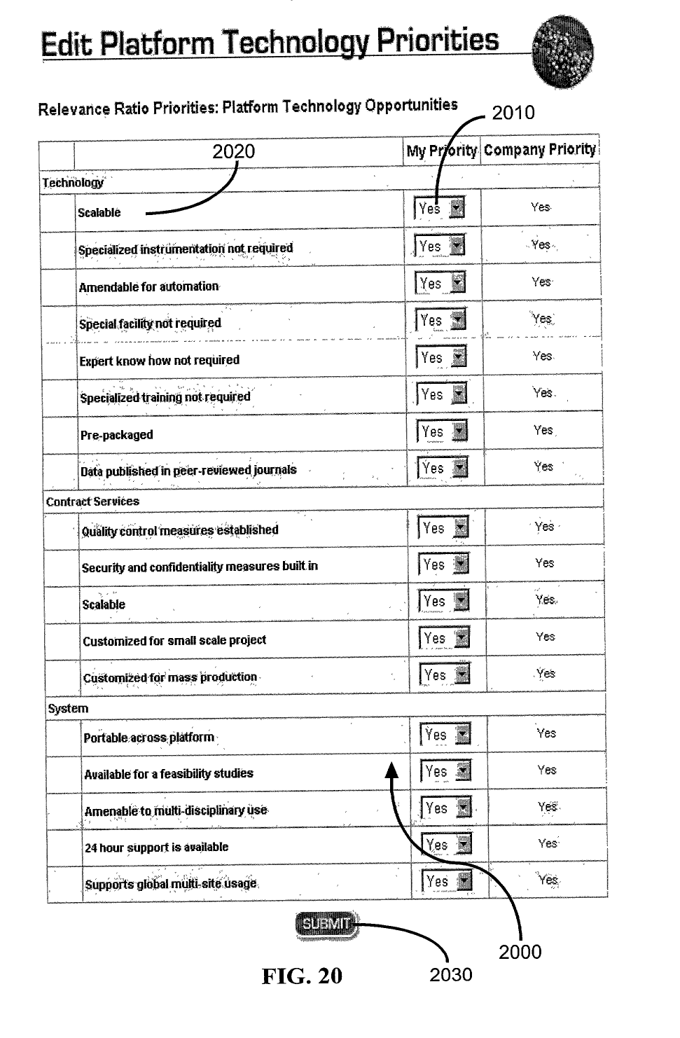

If the question is (Step 1660-Yes) the last question in the Relevance Ratio question set, then server 52 (FIG. 1) generates (Step 1670) a result for the opportunity. In the preferred embodiment, server 52 generates the result as a ratio, the numerator of the ratio being the First Sum and the denominator of the ratio being the Second Sum. (See column 2010, FIG. 20).

In other embodiments, the result is displayed in other formats, e.g., First Sum—Second Sum or as the numerical value of the above mentioned ratio. For example if the First Sum for an opportunity is 10 and the Second Sum for the opportunity is 14 then the value of the opportunity can be presented as 10/14, or as 10-14, or as 0.7143. In one embodiment, server 52 uses the relevance ratio to prioritizes the matched opportunities.

FIG. 17 illustrates a results GUI in accordance with an embodiment of the invention. The search results web page displays the relevance ratio 1710 for each opportunity that matches the buyer's search criteria. In addition, for each matching opportunity, web page 1700 displays an opportunity code 1720 assigned by a life science opportunity service provider, a product name or identification number 1730, and the listing seller's name 1740. A buyer views additional details about a matched opportunity by clicking on the opportunity code 1720 for the matching opportunity.

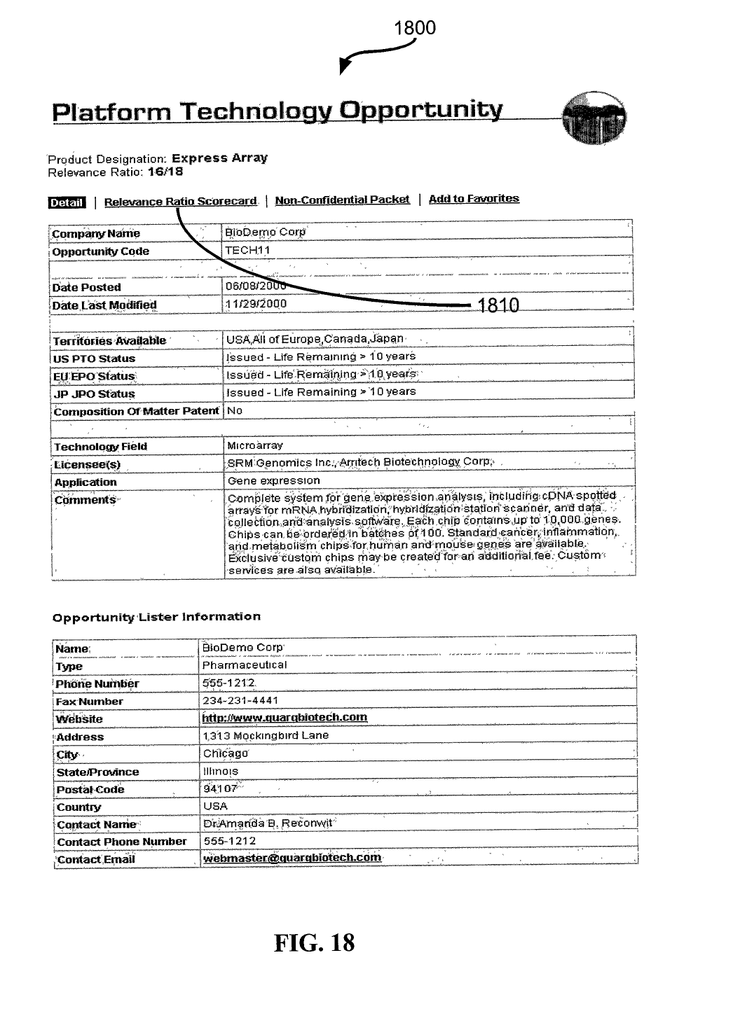

FIG. 18 illustrates a GUI containing a detailed description of an opportunity matching the buyer's search criteria in accordance with an embodiment of the invention. The buyer can view the seller's responses to the Relevance Ratio question set by clicking on the “Relevance Ratio Score Card” button 1810 on web page 1800.

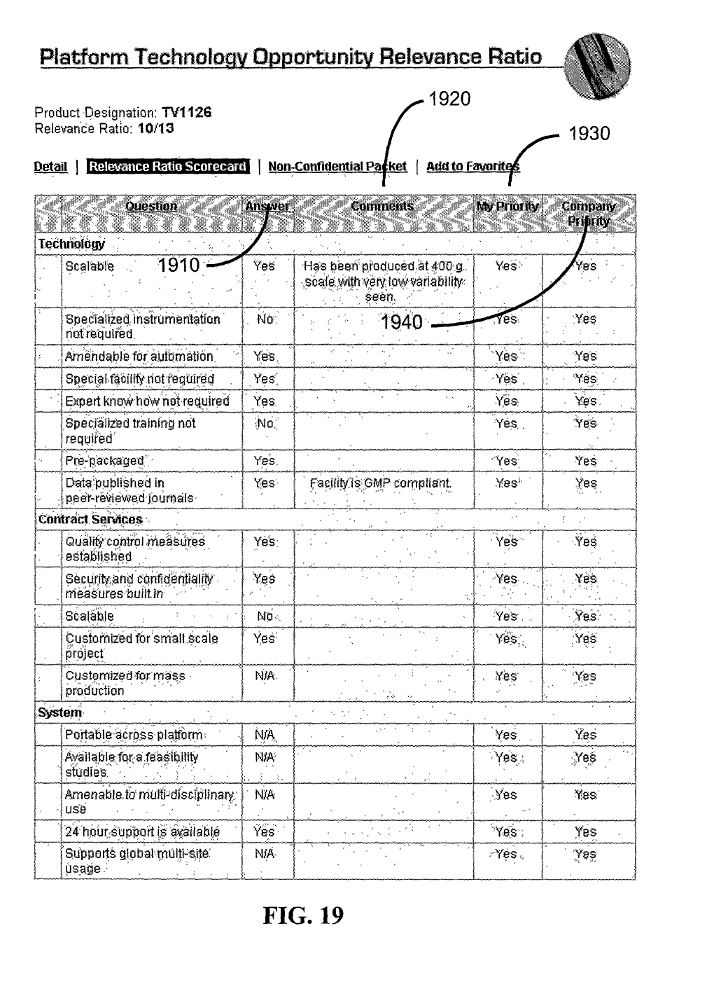

FIG. 19 illustrates a GUI containing the buyer's responses, the seller's responses, and the company's responses to the Relevance Ratio question set in accordance with an embodiment of the invention. GUI 1900 displays the seller's responses 1910 to the Relevance Ratio question set. GUI 1900 also displays the seller's comments to each question 1920, the buyer's preferences for each question 1930, and the buyer master user's responses 1940 to the Relevance Ratio question set.

Editing Priorities

FIG. 20 illustrates a GUI used to edit a buyer's priorities in accordance with an embodiment of the invention. The buyer's priorities indicate the buyer's preferences for an opportunity type. The “Edit Platform Technology Priorities” GUI 2000 contains the buyer's preferences 2010 for the opportunity type. The buyer edits responses 2010 to questions 2020 in the “Edit a Platform Technology Priorities” web page. In one embodiment, only the buyer master user may edit the buyer company's preferences for an opportunity type.

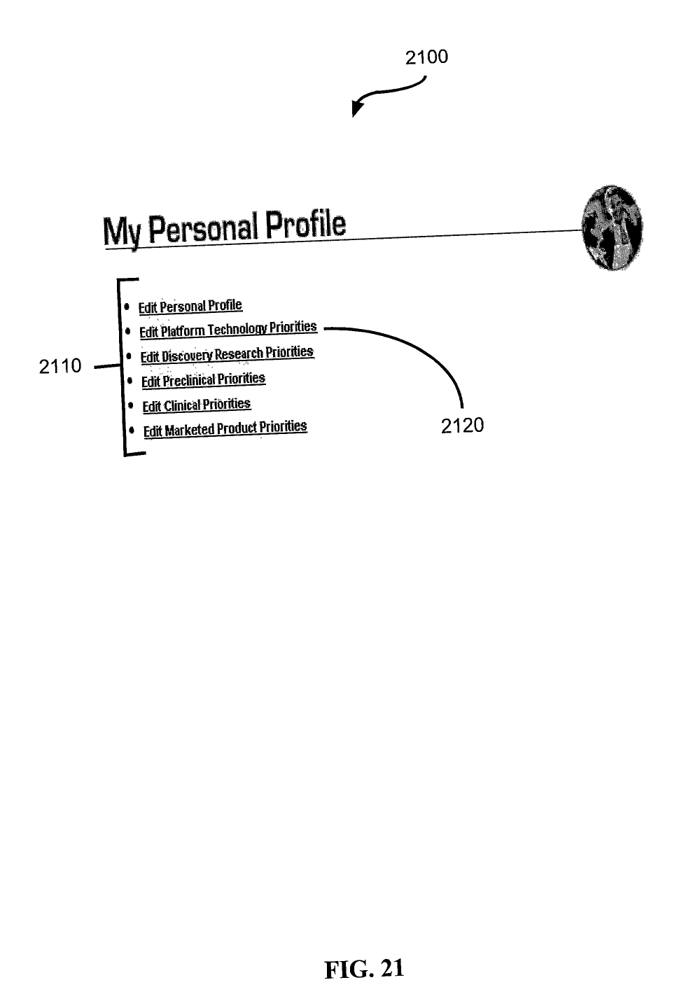

FIG. 21 illustrates a personal profile GUI in accordance with an embodiment of the invention. A buyer edits the priorities for an opportunity type by clicking on the corresponding edit button 2110 for an opportunity type from the personal profile web page. For example, a buyer can edit priorities for Platform Technology opportunity type by clicking on button 2120 in “My Personal Profile” web page 2100.

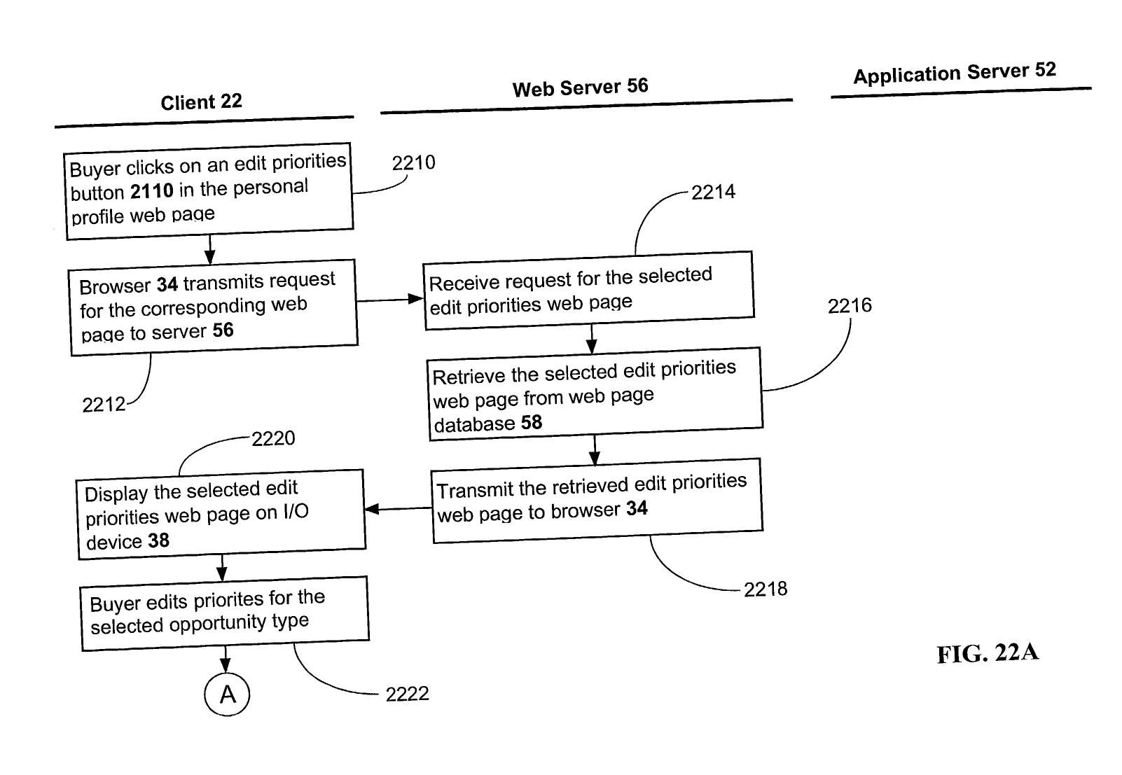

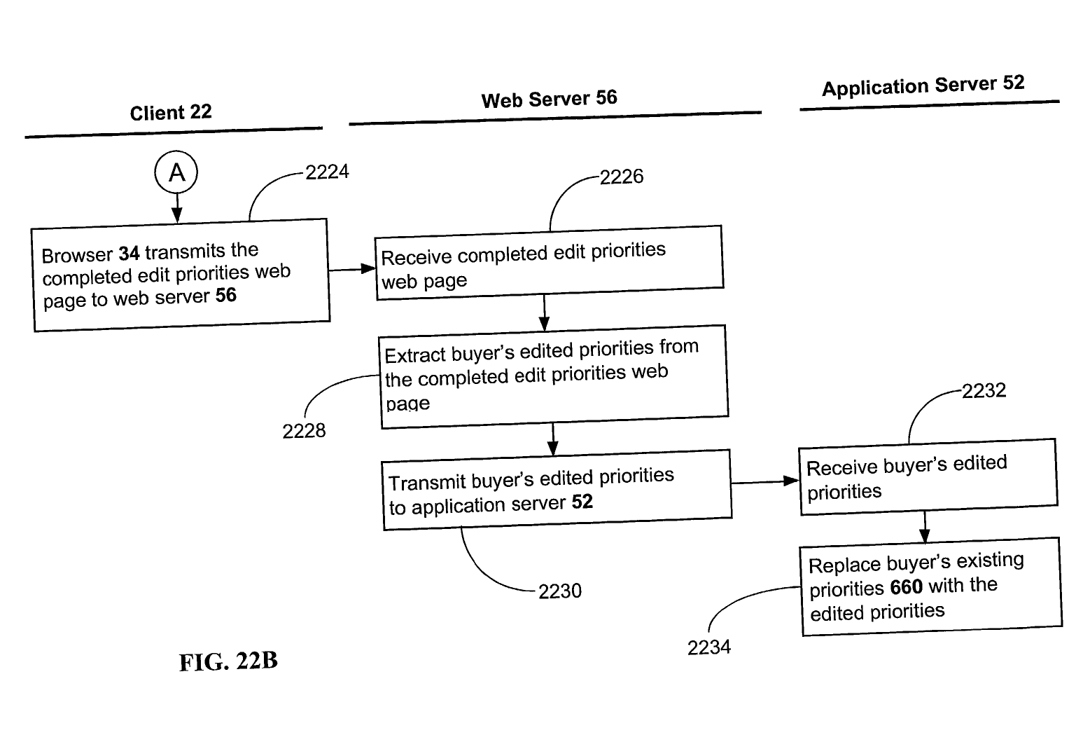

FIGS. 22A and 22B illustrate the processing steps performed when editing a buyer's priorities in accordance with an embodiment of the invention. A buyer edits the priorities for an opportunity type by clicking (Step 2210) on the corresponding edit button 2110 (FIG. 21) for an opportunity type from the personal profile web page. When the buyer clicks on button 2110 (FIG. 21), browser 34 (FIG. 1) transmits (Step 2212) a request for the corresponding edit priorities web page to web server 56 (FIG. 1). Web server 56 (FIG. 1) receives (Step 2214) the request for the edit priorities web page and retrieves (Step 2216) the corresponding web page from web page database 58 (FIG. 1). Web server 54 (FIG. 1) then transmits (Step 2218) the requested web page to browser 34 (FIG. 1) via network 26. Browser 34 (FIG. 1) displays (Step 2220) the edit priorities web page on input/output device 38 (FIG. 1).

Once the buyer has made (Step 2222) the desired changes to preferences 2010 (FIG. 20), the buyer submits the changes by clicking on the “SUBMIT” button 2030 (FIG. 20). Browser 34 (FIG. 1) transmits (FIG. 22B, Step 2224) the buyer's edited responses to web server 56 (FIG. 1). Web server 56 (FIG. 1) receives (Step 2226) the completed edit priorities web page, extracts (Step 2228) the buyer's responses from the edit priorities web page, and transmits (Step 2230) the buyer's edited responses to application server 52 (FIG. 1). Application server 52 (FIG. 1) receives (Step 2232) the buyer's edited priorities from web server 56 (FIG. 1) and replaces (Step 2234) the buyer's responses 660 (FIG. 6) to the Relevance Ratio question set with the edited responses to the Relevance Ratio question set.

Creating Opportunity Filters

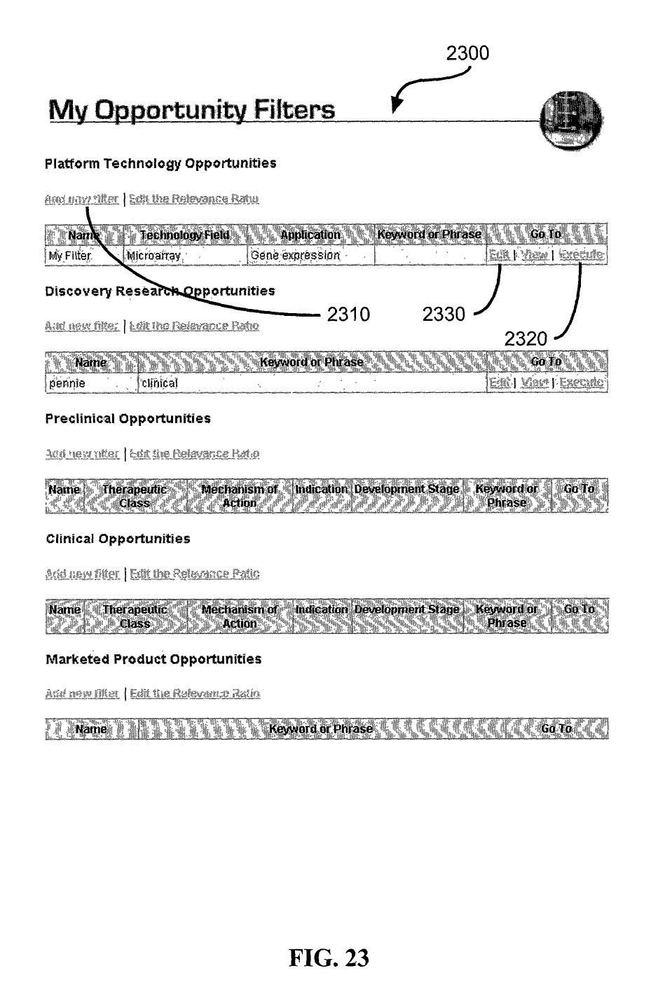

FIG. 23 illustrates a GUI containing the buyer's opportunity filters for each opportunity type in accordance with an embodiment of the invention. GUI 2300 displays a list of the buyer's opportunity filters for each opportunity type. The buyer adds a new filter to an opportunity type by clicking on the “Add new filter” button 2310 for the corresponding opportunity type. The buyer can conduct a search using a previously stored search filter criteria by clicking on the “EXECUTE” button 2320 on GUI 2300. Thus, a buyer need not provide the search criteria each time the buyer wants to search for opportunities that match the saved search criteria. The buyer can edit the saved search criteria at any time by clicking on “Edit” button 2330.

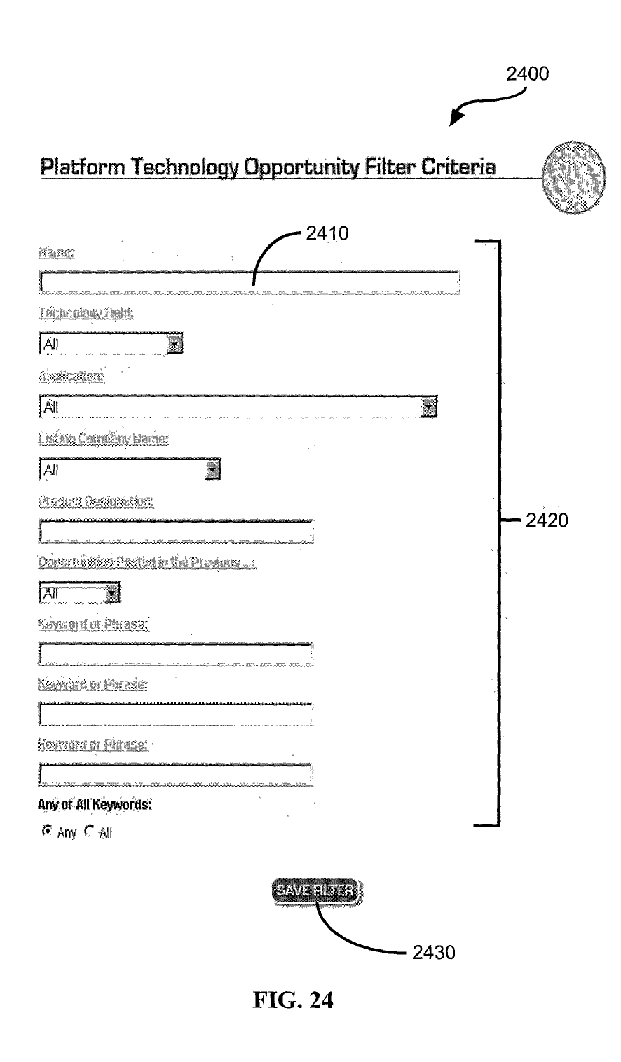

FIG. 24 illustrates a GUI for entering a buyer's search criteria for creating an opportunity filter in accordance with an embodiment of the invention. The buyer provides a name for the filter in field 2410. The buyer further provides one or more search criteria for the filter by completing fields 2420. After the buyer has entered the search criteria for the filter, the buyer saves the filter by clicking on the “SAVE FILTER” button 2430.

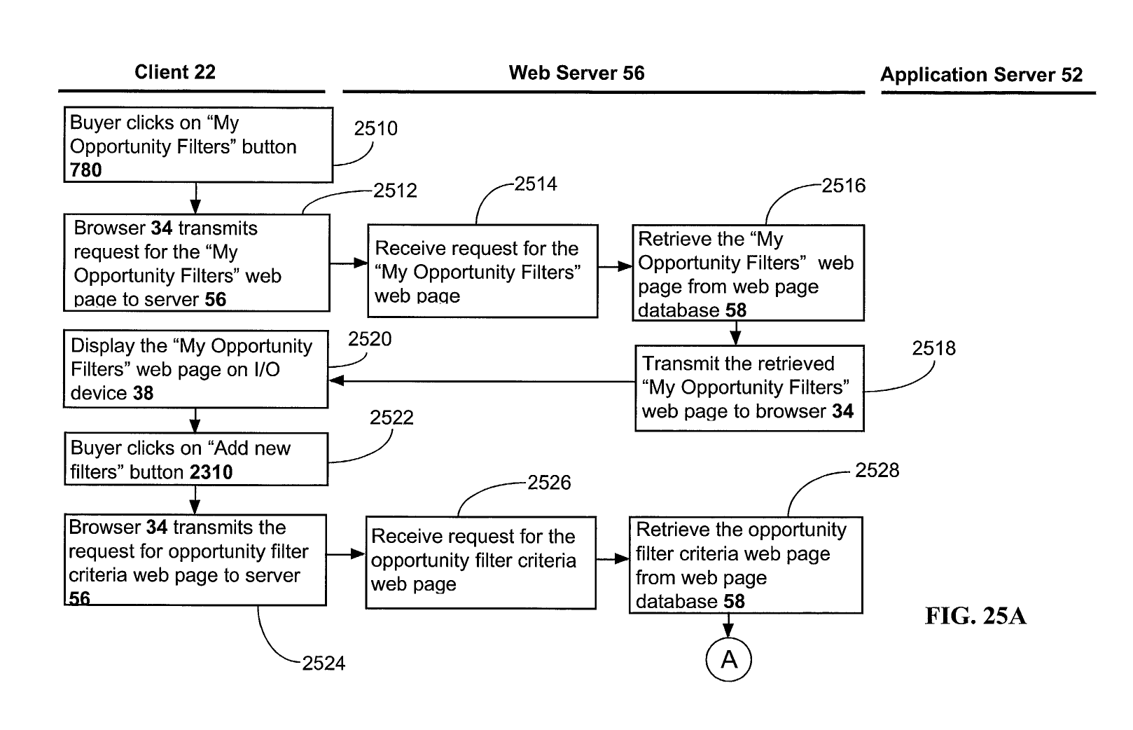

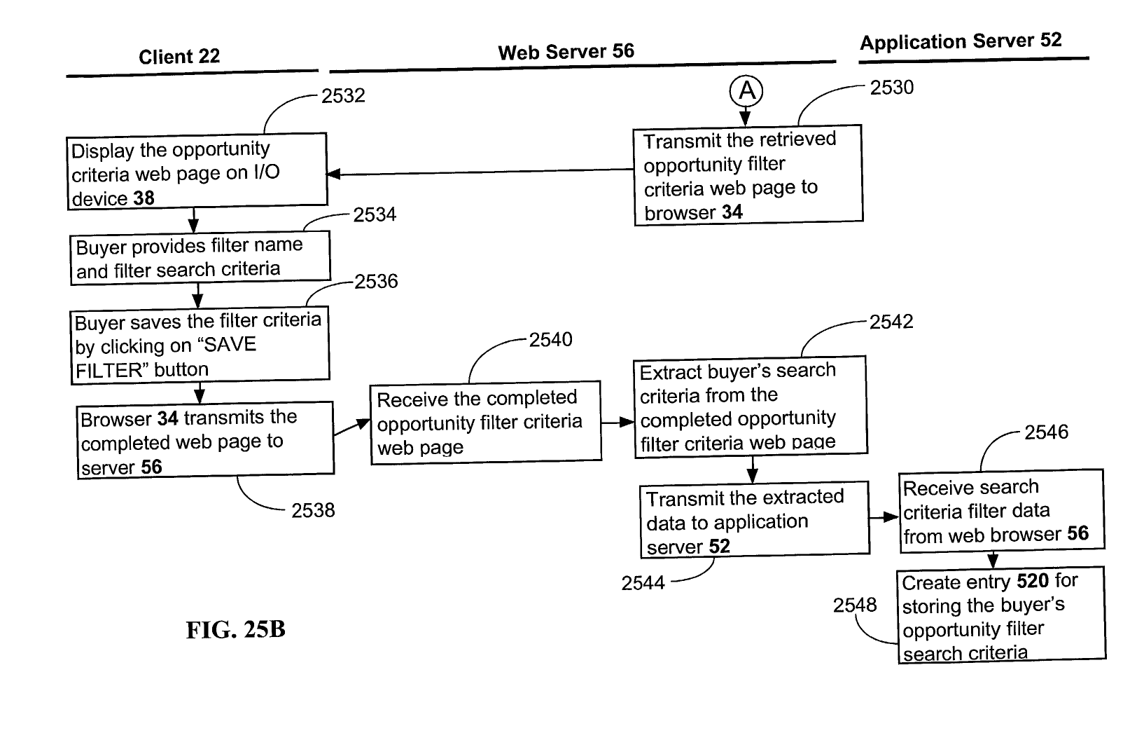

FIGS. 25A and 25B illustrate the processing steps performed when creating an opportunity filter in accordance with an embodiment of the invention. A buyer creates (Step 2510) an opportunity filter by clicking on the “My Opportunity Filters” button 770 (FIG. 7) on web page 700 (FIG. 7). When the buyer clicks on button 770 (FIG. 7), browser 34 (FIG. 1) transmits (Step 2512) a request for the “My Opportunity Filters” web page to web server 56 (FIG. 1).

Web server 56 (FIG. 1) receives (Step 2514) the request for the opportunity filters web page and retrieves (Step 2516) the requested web page from web page database 58 (FIG. 1). Web server 56 (FIG. 1) then transmits (Step 2518) the retrieved web page to browser 34 (FIG. 1) which subsequently displays (Step 2520) the web page on input/output device 38 (FIG. 1).

Illustratively, a buyer can create (Step 2510) an opportunity filter for platform technology opportunities by clicking on button 780 (FIG. 7) on web page 700 (FIG. 7). Browser 34 (FIG. 1) transmits (Step 2512) the request for the “My Opportunity Filters” web page to web server 56 (FIG. 1). Web server 56 (FIG. 1) receives (Step 2514) the request for the “My Opportunity Filters” web page from browser 34 (FIG. 1) and retrieves (Step 2516) the corresponding web page from web page database 58 (FIG. 1). Web server 56 (FIG. 1) then transmits (Step 2518) the requested web page to browser 34 (FIG. 1) which subsequently displays (Step 2520) the web page on input/output device 38 (FIG. 1).

The buyer then adds (Step 2522) a new filter to an opportunity type by clicking on the “Add new filter” button 2310 (FIG. 23) for the corresponding opportunity type. When the buyer clicks on the “Add new filter” button, browser 34 (FIG. 1) transmits (Step 2524) the request for the corresponding filter criteria web page to server 56 (FIG. 1). Server 56 (FIG. 1) receives (Step 2526) the request and retrieves (Step 2528) the requested web page from web page database 58 (FIG. 1). Web server 56 (FIG. 1) then transmits (FIG. 25B, Step 2530) the retrieved web page to browser 34 (FIG. 1). Browser 34 (FIG. 1) then displays (Step 2532) the opportunity filter criteria web page on input/output device 38 (FIG. 1).

The buyer provides a name for the filter in field 2410 (FIG. 24). The buyer further provides one or more search criteria for the filter by completing (Step 2534) fields 2420 (FIG. 24). After the buyer has entered the search criteria for the filter, the buyer saves (Step 2536) the filter by clicking on the “SAVE FILTER” button 2430 (FIG. 24). In the preferred embodiment, the buyer further has the option of receiving e-mail alerts when an opportunity matching the buyer's filter criteria is posted on system 20.

When the buyer clicks on the “SAVE FILTER” button, browser 34 (FIG. 1) transmits (Step 2538) the completed search criteria filter web page 2400 (FIG. 24) to web server 56 (FIG. 1). Web server 56 (FIG. 1) receives (Step 2540) the completed search criteria filter web page, extracts (Step 2542) the filter name and search criteria from the completed web page and transmits (Step 2544) the extracted information to application server 52 (FIG. 1). Application server 52 (FIG. 1) receives (Step 2546) the filter data and creates (Step 2548) an entry 520 (FIG. 5) for buyer 512 (FIG. 5) in buyer database 64 (FIG. 1).

The present invention can be implemented as a computer program product that includes a computer program mechanism embedded in a computer readable storage medium. For instance, the computer program product could contain the program modules shown in FIG. 1. These program modules may be stored on a CD-ROM, magnetic disk storage product, or any other computer readable data or program storage product. The software modules in the computer program product may also be distributed electronically, via the Internet or otherwise, by transmission of a computer data signal (in which the software modules are embedded) on a carrier wave.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

What is claimed

1. A method for facilitating a transaction of a life sciences opportunity between first and second parties, comprising:
receiving answers to predetermined life sciences opportunity questions from a first party;
acquiring responses to said predetermined life sciences opportunity questions from a second party;
calculating a first sum of all of said responses that match said answers, for each of said predetermined life sciences opportunity questions;
computing, from said answers and said responses, a second sum of all of said questions that both said first party and said second party deem to be applicable to said transaction, for each of said predetermined life sciences opportunity questions; and
displaying said first sum and said second sum to said second party, such that said second party can assess said life sciences opportunity.

2. The method of claim 1, further comprising a step prior to said displaying step of generating a ratio of said first sum to said second sum, where said ratio is an indication of compatibility of said life sciences opportunity to transaction requirements of said second party.

3. The method of claim 2, wherein said generating step comprises producing said ratio where a numerator of the ratio is the first sum and a denominator of the ratio is the second sum.

4. The method of claim 1, wherein said answers and said responses are selected from a group consisting of: “Yes”, “No,” and “Not Applicable.”

5. The method of claim 1, wherein said predetermined questions are technical questions relating to life sciences opportunities.

6. The method of claim 1, wherein said calculating step comprises determining said first sum of all of said responses that match said answers for each of said predetermined life sciences opportunity questions, and where each response and each answer are “Yes.”

7. The method of claim 1, wherein said computing step comprises determining from said answers and said responses, a second sum of all of said questions that said first party did not provide a “Not Applicable” answer to, and of all of said questions that said first party provided a “Yes” response to, for each of said predetermined life sciences opportunity questions.

8. The method of claim 1, further including the step of notifying the second party when a life sciences opportunity matching transaction requirements of said second party becomes available.

9. The method of claim 9, wherein the notifying step includes the step of sending an electronic message to the second party.

10. The method of claim 1, wherein said first party is a seller of a life sciences opportunity and said second party is a buyer of a life sciences opportunity.

11. A computer program product for use in conjunction with a computer system, the computer program product comprising a computer readable storage medium and a computer program mechanism embedded therein, the computer program mechanism comprising:
instructions for receiving answers to predetermined life sciences opportunity questions from a first party;
instructions for acquiring responses to said predetermined life sciences opportunity questions from a second party;
instructions for calculating a first sum of all of said responses that match said answers, for each of said predetermined life sciences opportunity questions;
instructions for computing, from said answers and said responses, a second sum of all of said questions that both said first party and said second party deem to be applicable to said transaction, for each of said predetermined life sciences opportunity questions; and
instructions for displaying said first sum and said second sum to said second party, such that said second party can assess said life sciences opportunity.

12. The computer program product of claim 12, further comprising instructions for generating a ratio of said first sum to said second sum, where said ratio is an indication of compatibility of said life sciences opportunity to transaction requirements of said second party.
